(19) United States
(12) Patent Application Publication
(10) Pub. No.: US 2018/0128070 A1
(43) Pub. Date: May 10, 2018

(54) DEGRADABLE DOWNHOLE TOOLS COMPRISING CELLULOSIC DERIVATIVES

(71) Applicant: Halliburton Energy Services, Inc., Houston, TX (US)

(72) Inventors: Andy Cheng CHANG, Houston, TX (US); Andre SOTO, Frisco, TX (US); Michael Linley FRIPP, Carrollton, TX (US)

(21) Appl. No.: 15/565,407

(22) PCT Filed: May 8, 2015
(86) PCT No.: PCT/US2015/029918

§ 371 Date: Oct. 9, 2017

(51) Int. Cl. E21B 23/00; E21B 29/00; C08B 11/16; C08B 11/18; C08B 3/06; C08B 3/08; C08B 5/02; C08B 5/14; C08B 7/00

(52) U.S. Cl. CPC E21B 23/00; E21B 29/00; C08B 11/16; C08B 11/18; E21B 33/128; C08B 3/08; C08B 5/02; C08B 5/14; C08B 7/00; C08B 3/06

(57) ABSTRACT

A downhole tool or component thereof comprising a cellulosic derivative, wherein the cellulosic derivative is capable of at least partially degrading in a wellbore environment, thereby at least partially degrading the downhole tool or component thereof. Methods of introducing the downhole tool into a wellbore environment, performing a downhole operation, and at least partially degrading the downhole tool or component therein in the wellbore.

### BACKGROUND

The present disclosure generally relates to degradable downhole tools and components thereof and, more specifically, to degradable downhole tools and components thereof comprising cellulosic derivatives that at least partially degrade upon exposure to a wellbore environment.

A variety of downhole tools may be used within a wellbore in connection with producing or reworking a hydrocarbon bearing subterranean formation. The downhole tool may comprise a wellbore isolation device, as an example, capable of fluidly sealing two sections of the wellbore from one another and maintaining differential pressure (i.e., to isolate one pressure zone from another). The wellbore isolation device may be used in direct contact with the formation face of the wellbore, a tool string such as a casing string or a liner, with a screen or wire mesh, and the like.

After the production or reworking operation is complete, the seal formed by the downhole tool must be broken and the tool itself removed from the wellbore. The downhole tool must be removed to allow for production or further operations to proceed without being hindered by the presence of the downhole tool. Removal of the downhole tool(s) is traditionally accomplished by complex retrieval operations involving milling or drilling the downhole tool for mechanical retrieval. In order to facilitate such operations, downhole tools have traditionally been composed of drillable metal materials, such as cast iron, brass, or aluminum. These operations can be costly and time consuming, as they involve introducing a tool string into the wellbore, milling or drilling out the downhole tool (e.g., at least breaking the seal), and mechanically retrieving the downhole tool or pieces thereof from the wellbore and to the surface.

To reduce the cost and time required to mill or drill a downhole tool from a wellbore for its removal, dissolvable or degradable downhole tools have been developed. Traditionally, however, such dissolvable downhole tools have been designed only such that the dissolvable portion includes the tool mandrel itself and not any sealing element of the downhole tool. Moreover, traditional degradable tool bodies have been made of degradable polymers, degradable metals, or salts that have quasi static properties (i.e., that exhibit a particular physical state, such as rigidity or brittleness, without being otherwise adaptable). Additionally, traditional materials used for degrading the mandrel of a downhole tool involve complicated, time consuming, and expensive manufacturing processes.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a cross-sectional view of a well system comprising a downhole tool, according to one or more embodiments described herein.

FIG. 2 depicts an enlarged cross-sectional view of a wellbore isolation device tool, according to one or more embodiments described herein.

FIG. 3 depicts a cross-sectional view of a perforating gun tool, according to one or more embodiments described herein.

FIG. 4 shows an enlarged cross-sectional interior view of a perforating gun tool, according to one or more embodiments described herein

FIG. 5 illustrates a cross-sectional view of a well screen tool, according to one or more embodiments described herein.

### DETAILED DESCRIPTION

The present disclosure generally relates to degradable downhole tools and components thereof and, more specifically, to degradable downhole tools and components thereof comprising cellulosic derivatives that at least partially degrade upon exposure to a wellbore environment. As used herein, the term “cellulosic derivative” refers to any compound that is made from cellulose, for example, by replacing one atom in one of the listed compounds with another atom or group of atoms, ionizing one of the listed compounds, or creating a salt of one of the listed compounds. As used herein, the term “degradable” and grammatical variants thereof (e.g., “degrade,” “degradation,” “degraded,” “degrading,” and the like) refers to the dissolution or chemical conversion of materials into smaller components, intermediates, or end products by at least one of solubilization, hydrolytic degradation, biologically formed entities (e.g., bacteria or enzymes), chemical reactions, electrochemical processes, thermal reactions, or reactions induced by radiation.

Disclosed are various embodiments of a degradable downhole tool or component thereof, including sealing elements capable of fluidly sealing two sections of a wellbore (which may also be referred to as “setting” the downhole tool). The downhole tool may have various setting mechanisms for fluidly sealing the sections of the wellbore with the sealing element including, but not limited to, hydraulic setting, mechanical setting, setting by swelling, setting by inflation, and the like. The degradable downhole tool or component thereof may be a well isolation device or “plug,” such as a frac plug, a bridge plug, a packer, a wiper plug, a cement plug, or any other tool requiring a sealing element for use in a downhole operation. The degradable downhole tool, in other embodiments, may be a perforating gun or component thereof (e.g., a charge carrier component), a well screen tool (e.g., a sand screen to exclude formation fines from produced fluids), and the like.

While the compositions and methods of the present disclosure may be described in terms of particular downhole tools and components thereof, it will be appreciated that the cellulosic derivatives described herein may be used in any downhole tool or component thereof that may benefit from their unique properties, including degradability, elasticity, and/or adhesiveness, as described in detail below, without departing from the scope of the present disclosure. Examples of such downhole tools may include, but are not limited to, a chemical delivery tool (e.g., for removal of a filter cake), a hydraulic fracturing tool, a downhole actuation tool, a well screen tool (e.g., a sand screen), a drilling tool, a safety for a perforating device, a sensor device, a conformance/water control device, and the like. Moreover, it will be appreciated by one of skill in the art that while the embodiments herein are described with reference to a downhole tool, the degradable cellulosic derivatives disclosed herein may be used with any wellbore operation equipment that may preferentially degrade upon exposure to a wellbore environment.

In some embodiments, the degradable downhole tool or component thereof may comprise a cellulosic derivative, wherein the cellulosic derivative is capable of at least partially degrading in a wellbore environment, thereby at least partially degrading the downhole tool or component thereof. In some embodiments, the entirety of the downhole tool may be made of the cellulosic derivative. In other embodiments, only a portion of the downhole tool may be made of the cellulosic derivative. In yet other embodiments, some portion of the downhole tool may be made of a cellulosic derivative, while another portion of the downhole tool may be made of one or more other degradable materials, such as a degradable metal (e.g., degradable by galvanic corrosion), a degradable polymer (e.g., polylactic acid), and the like, and combinations thereof. In still other embodiments, the downhole tool or component thereof may comprise the cellulosic derivative in a mixture with another material (degradable or otherwise), such that the degradation of the cellulosic derivative is sufficient to cause the downhole tool or component thereof to lose enough structural integrity to be removed from a downhole location without the need to drill or mill the tool or component therefrom.

In yet other embodiments, the cellulosic derivative may form a protective coating surrounding a downhole tool or component thereof, which may be removable at a downhole location to allow the downhole tool or component thereof to properly function. For example, the cellulosic derivative coating may be formed around a downhole tool or component thereof to protect it from the external environment prior to its use in operation, such as at an offshore location having a high salinity environment capable of readily degrading certain traditionally used degradable materials to form portions or all of the downhole tool. As another example, the cellulosic derivative coating may allow prolonged storage and/or otherwise protect the downhole tool or component thereof during handling in the supply chain.

The cellulosic derivatives described herein may be beneficial for use in forming a downhole tool or component thereof due to a number of advantages. Such advantages may include, but are not limited to, heat resistance, melting points substantially similar to many downhole temperature conditions (e.g., in the range of between about 67° C. and about 250° C., encompassing any value and subset therebetween), and glass transition temperatures similar to many downhole temperature conditions and capable of being in a rigid or softened (e.g., as a sealing element) state depending on such conditions (e.g., in the range of between about 96° C. and about 189° C., encompassing any value and subset therebetween). Additionally, the cellulosic derivatives described herein may be thermoplastic, allowing them to be melted and molded into the downhole tools or components thereof (or other geometrical shapes) with relative ease. Their thermoplastic nature also allows blending with other components (e.g., fillers, fibers, such as carbon fibers, and the like) with relative ease to alter the structural integrity of the downhole tool or component thereof. Moreover, the cellulosic derivatives are widely commercially available and environmentally safe, as compared to other degradable materials.

The cellulosic derivatives described herein also have similar tensile stress (or break stress) and modulus profiles to metals or other materials typically used in forming typical downhole tools and components therein. Accordingly, such typical materials may be replaced by the cellulosic derivatives without a loss in function to the downhole tool or component thereof in terms of structural rigidity. Moreover, any slight differences in the tensile strength or modulus of the cellulosic derivatives may be compensated for, such as by increasing the thickness of the particular downhole tool or component, or the like. The cellulosic derivatives described herein are also impact resistant (e.g., not brittle) and thus suitable for use as a downhole tool or component thereof and are not immediately susceptible, although they may be designed to be so, to salinity and pH, as compared to traditional degradable materials, such as polylactic acid. Accordingly, in high salinity and high pH fluids, the cellulosic derivatives may have degradation profiles that are slower than such traditional degradable materials.

Degradation of the cellulosic derivative forming at least a portion of the downhole tool or component thereof may occur in situ without the need to mill or drill and retrieve the downhole tool from the wellbore. In some cases, the downhole tool or component thereof may at least partially degrade such that it is no longer capable of isolating sections of the wellbore (i.e., it is not able to maintain a position in the wellbore) and may otherwise have portions that have not degraded, the non-degraded portions may drop into a rathole in the wellbore, for example, without the need for retrieval, or may be sufficiently degraded in the wellbore so as to be generally indiscernible. In various alternate embodiments, degrading one or more components of a downhole tool or component thereof may perform an actuation function, such as to open a passage, release a retained member, or otherwise change the operating mode of the downhole tool, and in some embodiments such an actuation function may be achieved by an actuator or an actuator control device comprising or composed of a cellulosic derivative.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having the benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressed in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques. As used herein, the term “about” may be +/−5% of a numerical value.

As used herein, the term “substantially” means largely, but not necessarily wholly.

While compositions and methods are described herein in terms of “comprising” various components or steps, the compositions and methods can also “consist essentially of” or “consist of” the various components and steps. When “comprising” is used in a claim, it is open-ended.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

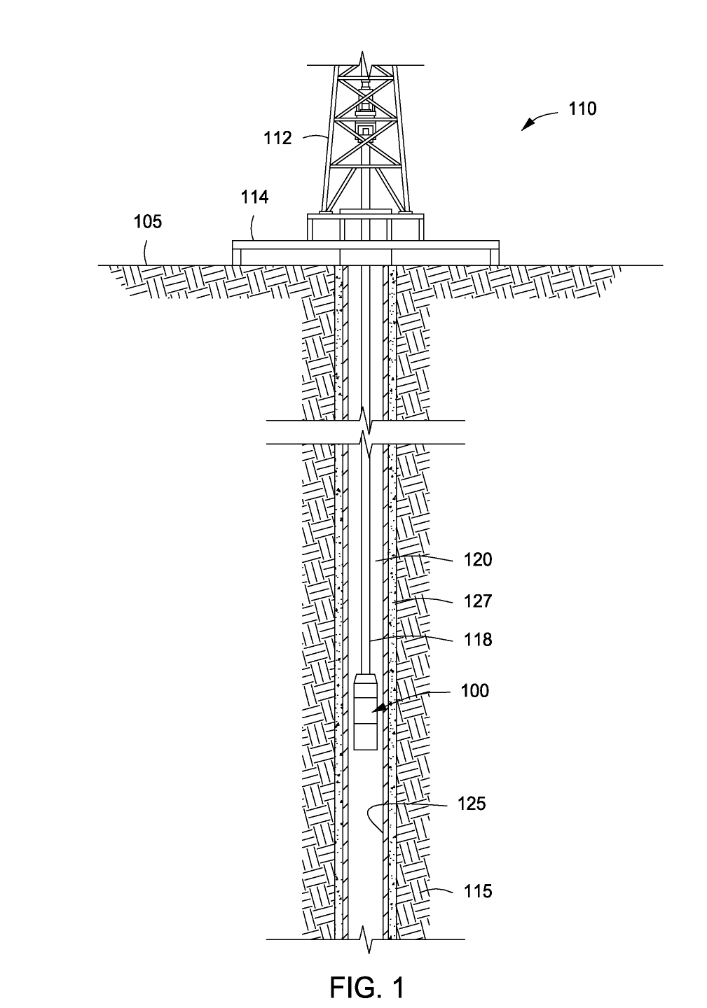

Referring now to FIG. 1, illustrated is an exemplary well system 110 for a downhole tool 100. As depicted, a derrick 112 with a rig floor 114 is positioned on the earth's surface 105. A wellbore 120 is positioned below the derrick 112 and the rig floor 114 and extends into subterranean formation 115. As shown, the wellbore 120 be lined with casing 125 that is cemented into place with cement 127. It will be appreciated that although FIG. 1 depicts the wellbore 120 having a casing 125 being cemented into place with cement 127, the wellbore 120 may be wholly or partially cased and wholly or partially cemented (i.e., the casing wholly or partially spans the wellbore and may or may not be wholly or partially cemented in place), without departing from the scope of the present disclosure. Moreover, the wellbore 120 may be an open-hole wellbore. A tool string 118 extends from the derrick 112 and the rig floor 114 downwardly into the wellbore 120. The tool string 118 may be any mechanical connection to the surface, such as, for example, wireline, slickline, jointed pipe, or coiled tubing. As depicted, the tool string 118 suspends the downhole tool 100 for placement into the wellbore 120 at a desired location to perform a specific downhole operation. As previously mentioned, the downhole tool 100 may be a wellbore isolation device, a perforating gun, a well screen tool, a drilling tool, and the like, and any combination thereof.

It will be appreciated by one of skill in the art that the well system 110 of FIG. 1 is merely one example of a wide variety of well systems in which the principles of the present disclosure may be utilized. Accordingly, it will be appreciated that the principles of this disclosure are not necessarily limited to any of the details of the depicted well system 110, or the various components thereof, depicted in the drawings or otherwise described herein. For example, it is not necessary in keeping with the principles of this disclosure for the wellbore 120 to include a generally vertical cased section. The well system 110 may equally employ vertical and/or deviated wellbores, without departing from the scope of the present disclosure. Furthermore, it is not necessary for a single downhole tool 100 to be suspended from the tool string 118. In addition, it is not necessary for the downhole tool 100 to be lowered into the wellbore 120 using the derrick 112. Rather, any other type of device suitable for lowering the downhole tool 100 into the wellbore 120 for placement at a desired location may be utilized without departing from the scope of the present disclosure such as, for example, mobile workover rigs, well servicing units, cable deploying units, and the like. Although not depicted, the downhole tool 100 may alternatively be hydraulically pumped into the wellbore and, thus, not need the tool string 118 for delivery into the wellbore 120.

As described above, in some embodiments, the downhole tool 100 may be a wellbore isolation device that provides fluid sealing between two wellbore sections, such as a frac plug, a bridge plug, a packer, a wiper plug, a cement plug. Generally, regardless of the specific structure or type of wellbore isolation device, such wellbore isolation devices may have one or more components including, but not limited to, a sealing element, a spacer ring, a slip, a wedge, a retainer ring, an extrusion limiter, a backup shoe, a mule shoe, a tapered shoe, a flapper, a ball (e.g., a frac ball), a ball seat, an o-ring (e.g., as part of a ball seat), a sleeve, an enclosure (e.g., a chemical solution enclosure), a fluid enclosure, a dart, a valve (e.g., an operating valve that is opened by degradation of a cellulosic derivative described herein or an operating valve is held open by the cellulosic derivative until it degrades), a connection (e.g., a component that connects one or more other components of the downhole tool, such as by adhesion or mechanical means), a latch, an actuator, an actuation control device, a mandrel, and any combination thereof. Such components may also form a part of other types of downhole tools, as well.

The downhole tool 100 and component thereof may be comprised of the same material or, as is generally the case, certain components of the downhole tool 100 may be of a material to lend rigidity thereto (e.g., a main mandrel of the downhole tool) and other components may be of a material to lead elasticity or residency thereto (e.g., a sealing element). For illustrative purposes, when the downhole tool 100 is a wellbore isolation device, it may be described herein as having a mandrel and a sealing element. Both the mandrel and the sealing element may be considered “components” of the wellbore isolation device, and each may be comprised of one or more degradable cellulosic derivatives. Although such wellbore isolation devices may be described herein for illustrative purposes as having a mandrel and a sealing element, it will be appreciated that any number of other components may also form a portion thereof including those listed in the present disclosure, without departing from the scope of the present disclosure.

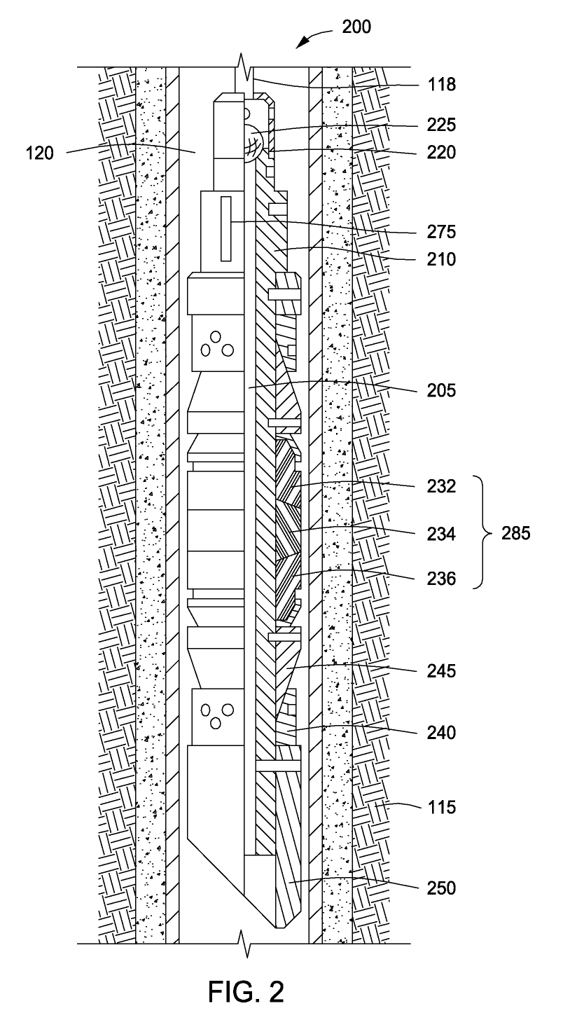

Referring now to FIG. 2, with continued reference to FIG. 1, an exemplary downhole tool 100 is shown as a wellbore isolation device. For illustrative purposes, the wellbore isolation device is depicted as a frac plug 200, which may be used during a well stimulation/fracturing operation. FIG. 2 illustrates a cross-sectional view of the exemplary frac plug 200 being lowered into a wellbore 120 on a tool string 118. As previously mentioned, the frac plug 200 may comprise a mandrel 210 and a sealing element 285. The sealing element 285, as depicted, comprises an upper sealing element 232, a center sealing element 234, and a lower sealing element 236. It will be appreciated that although the sealing element 285 is shown as having three portions (i.e., the upper sealing element 232, the center sealing element 234, and the lower sealing element 236), any other number of portions, or a single portion, may also be employed without departing from the scope of the present disclosure.

As depicted, the sealing element 285 is extending around the mandrel 210. However, it may be of any other configuration suitable for allowing the sealing element 285 to form a fluid seal in the wellbore 120, without departing from the scope of the present disclosure. For example, in some embodiments, the mandrel may comprise two sections joined together by the sealing element, such that the two sections of the mandrel compress to permit the sealing element to make a fluid seal in the wellbore 120. Other such configurations are also suitable for use in the embodiments described herein. Moreover, although the sealing element 285 is depicted as located in a center section of the mandrel 210, it will be appreciated that it may be located at any location along the length of the mandrel 210, without departing from the scope of the present disclosure.

The mandrel 210 of the frac plug 200 comprises an axial flowbore 205 extending therethrough. A ball seat 220 is formed at the upper end of the mandrel 210 for retaining a ball 225 that acts as a one-way check valve. In particular, the ball 225 seals off the flowbore 205 to prevent flow downwardly therethrough, but permits flow upwardly through the flowbore 205. One or more slips 240 are mounted around the mandrel 210 below the sealing element 285. The slips 240 are guided by a mechanical mandrel slip 245. A tapered shoe 250 is provided at the lower end of the mandrel 210 for guiding and protecting the frac plug 200 as it is lowered into the wellbore 120. An optional enclosure 275 for storing a chemical solution may also be mounted on the mandrel 210 or may be formed integrally therein. In one embodiment, the enclosure 275 is formed of a frangible material, rather than a degradable material, such as the cellulosic derivative described herein.

One or both of the mandrel 210 and the sealing element 285, or any other component of the downhole tool 100 (FIG. 1) or the frac plug 200, may comprise a degradable cellulosic derivative in an amount sufficient to at least partially degrade the tool or component thereof. In operation, the frac plug 200 may be used to seal two portions of a wellbore 120 (FIG. 1) and allow fluid recovery operations. After the fluid recovery operations are complete, the frac plug 200 must be removed from the wellbore 120. In this context, at least a portion of the frac plug 200 may degrade by exposing the frac plug 200 and components thereof that have been formed with the cellulosic derivative to the wellbore environment. Accordingly, in an embodiment, the frac plug 200 is designed to decompose over time while operating in a wellbore environment, thereby eliminating the need to mill or drill the frac plug 200 out of the wellbore 120. Thus, by exposing the frac plug 200 to the wellbore environment over time, the cellulosic derivative will decompose, causing the frac plug 200 to lose structural and/or functional integrity and release from the casing 125. The remaining portions of the plug 200 may simply fall to the bottom of the wellbore 120.

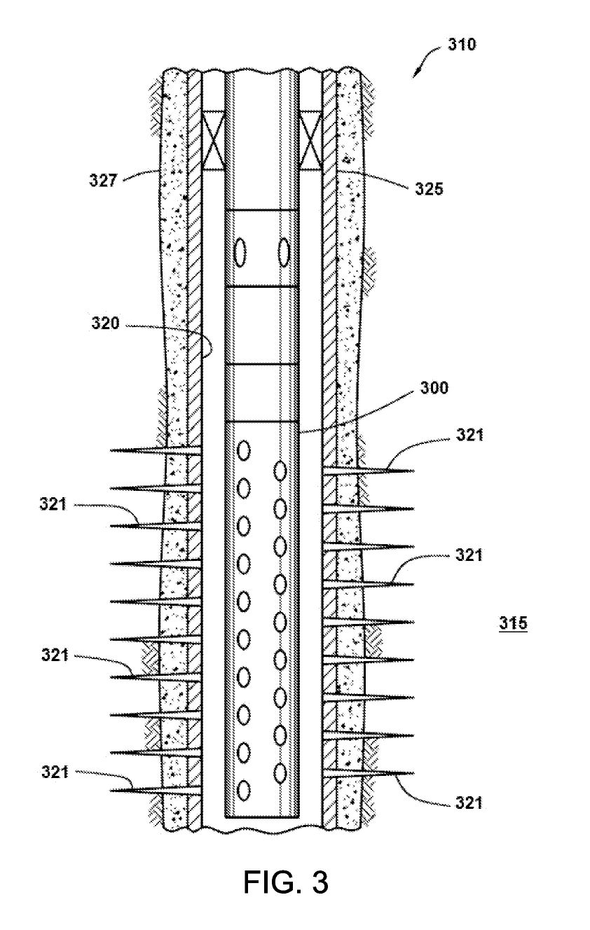

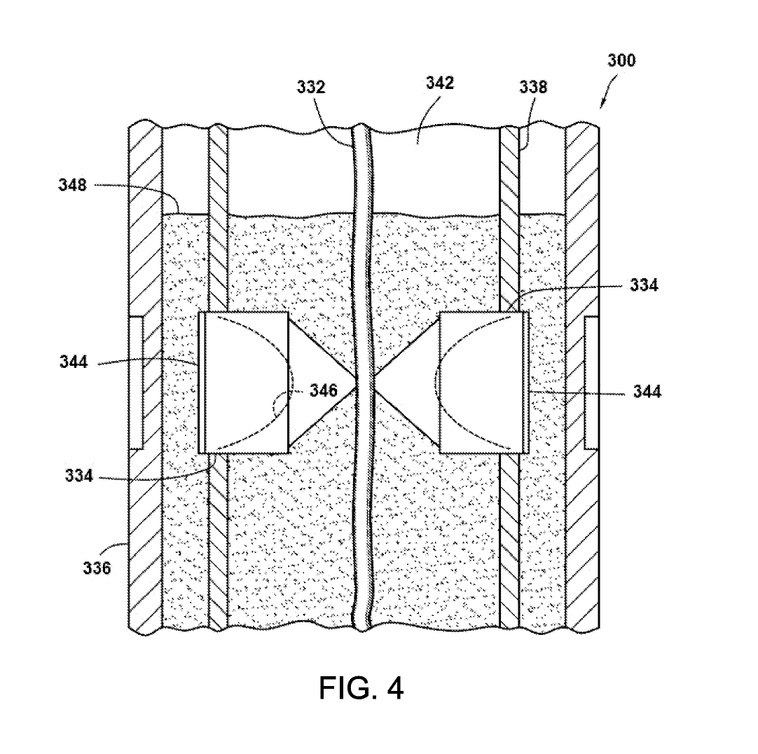

Referring now to FIG. 3, with continued reference to FIG. 1, illustrated is a downhole tool 100 (FIG. 1) shown as a perforating gun 300, that may be composed wholly or partially (i.e., a component thereof) of the cellulosic derivatives described herein. Illustrated is a well system 310, which may be substantially similar to the well system 110 in FIG. 1. In the depicted embodiment, a wellbore 320 extends into a subterranean formation 315. As shown, the wellbore 320 may be lined with a casing 325 that may be wholly or partially cemented in place with cement 327 in the wellbore 320. Disposed in the wellbore 320 (e.g., by a tool string 118 (FIG. 1)) is a perforating gun 300. Perforating charges 334 (shown in FIG. 4) are contained within a charge carrier 338 (shown in FIG. 4) and detonated to form the perforations 321 through the casing 325 and cement 327 into the subterranean formation 315. Each of the connection components of the perforating gun 300 are illustrated as horizontal lines on the tool in FIG. 3 (not labeled), each of which may itself be formed from a cellulosic derivative having adhesive properties, as described below, which may be degraded in the wellbore environment to cause the perforating gun 300 to be broken into smaller products that may drop to the bottom of the wellbore 320.

Referring now to FIG. 4, with continued reference to FIG. 3, illustrated is a cross-sectional view of a portion of the perforating gun 300 which may be wholly or partially comprising the cellulosic derivatives described herein. As shown, the perforating gun 300 may generally have a tubular outer body 336, perforating charges 334, and a tubular charge carrier 338. Although the outer body 336 and the charge carrier 338 are depicted as being tubular in shape, it will be appreciated that they may be any shape provided that they are capable of being retained in a perforating gun 300 that may be used in a particular subterranean formation 315, without departing from the scope of the present disclosure. For example, the outer body 336 and/or the charge carrier 338 may be rectangular-shaped, conical-shaped, cone-shaped, strip-shaped (i.e., flat strips), and the like.

As depicted, a detonating cord 332 may be used to transfer a detonation train along the length of the perforating gun 300 and to each perforating charge 334. As shown in FIG. 4, two perforating charges 334 are depicted in-line with one another. It will be appreciated, however, that the perforating gun 300 may comprise any number of perforating charges 334 and in any arrangement relative to one another (e.g., randomly arranged, symmetrically arranged, and the like), without departing from the scope of the present disclosure. Moreover, it is not necessary that all of the components described in FIG. 4 to be present within the perforating gun 300 and, similarly, other components may also be present in the perforating gun 300, without departing from the scope of the present disclosure.

In some embodiments, each of the perforating charges 334 may have a cover 344 positioned over the outer ends thereof (i.e., the end of the perforating charges 334 closes to the outer body 336). The cover 344 may prevent material from entering into the interior 346 of the perforating charges 334 (e.g., material introduced into the subterranean formation or material produced from the subterranean formation). For example, following detonation, a reduction in the pressure of the wellbore 320 may occur due to fluids in the wellbore 320 flowing into the now-perforated perforating gun 300. As depicted, such fluid may flow into a free gun volume 342 of the perforating gun 300, and the pressure fluctuations may be controlled by the addition of a material 348 within the free gun volume 342. For example, by reducing the free gun volume 342, the pressure reduction in the wellbore 320 following detonating the perforating charges 334 may also be reduced because the fluid in the wellbore 320 will have less volume to occupy in the perforating gun 300. Although the perforating gun 300 is depicted as having a free gun volume 342 where material 348 may be introduced therein to control pressure fluctuations in the wellbore 320, such a configuration is not required in accordance with the embodiments described herein.

All or a portion of the perforating gun 300 (e.g., components thereof) may comprise a degradable cellulosic derivative in an amount sufficient to at least partially degrade the tool or component thereof. For example, one or more of the outer body 336, the charge carrier 338, or the cover 344 may comprise a degradable cellulosic derivative, as described herein. In some embodiments, the charge carrier 338 may be preferably at least partially comprised of the cellulosic derivative to allow degradation thereof in a downhole environment. As used herein, the term “downhole environment” may be used interchangeably with “wellbore environment.” The charge carrier 338 may be preferably degradable within at least about 100 hours after placement in the wellbore. That is, the charge carrier 338 may be degradable after placement in the wellbore within about 90 hours, or about 80 hours, or about 70 hours, or about 60 hours, or about 50 hours, or about 40 hours, or about 30 hours, or about 20 hours, or about 10 hours, or about 5 hours, or about 1 hour, or about 30 minutes, or about 1 minute, or even less, encompassing any value and subset therebetween, without departing from the scope of the present disclosure.

As an example, in some embodiments, the charge carrier 338 may degrade after actuation of the tool, and such degradation may occur within a lower limit of about 1 minute to an upper limit of about 100 hours after actuation, or within a lower limit of about 1 minute to an upper limit of about 50 hours after actuation, or within a lower limit of about 1 minute to an upper limit of about 25 hours after actuation, encompassing any value and subset therebetween. In other embodiments, the actuation of one or more functions of the perforating gun 300 (or other downhole tools described herein) may release one or more agents (e.g., one or more of a solubilization degradation agent, a hydrolytic degradation agent, a biologically formed degradation agent (e.g., bacteria or enzymes), a chemical reactant degradation agent, an electrochemical degradation agent, a thermal degradation agent, a radiation induced or inducing degradation agent, and the like, and any combination thereof) which accelerates the rate of degradation of the charge carrier 338.

In some embodiments, in the degradation times described herein, the charge carrier 338 my degrade such that it experiences a weight loss in the range of a lower limit of about 5%, 10%, 15%, 20%, 25%, 30%, 35%, 40%, 45%, and 50% to an upper limit of about 100%, 95%, 90%, 85%, 80%, 75%, 70%, 65%, 60%, 55%, and 50%, encompassing any value and subset therebetween. For example, in some embodiments, in the degradation times described herein, the charge carrier 338 may degrade such that it experiences a weight loss in the range of about 7% to about 100%, or about 10% to about 100%, or about 15% to 100%, or a more narrow range, without departing from the scope of the present disclosure. Each degradation amount is critical to the methods described herein and depends on the size of the charge carrier 338, the material of the charge carrier 338, and the like. Weight loss describing the degradation herein is measured as a percentage of the material that can be degraded.

Components of the perforating gun 300 may otherwise be composed of materials, in addition to the cellulosic material, such as, for example, another degradable material (e.g., those described herein), metal, plastic, formed wire, molded casts, ceramic, and the like, without departing from the scope of the present disclosure.

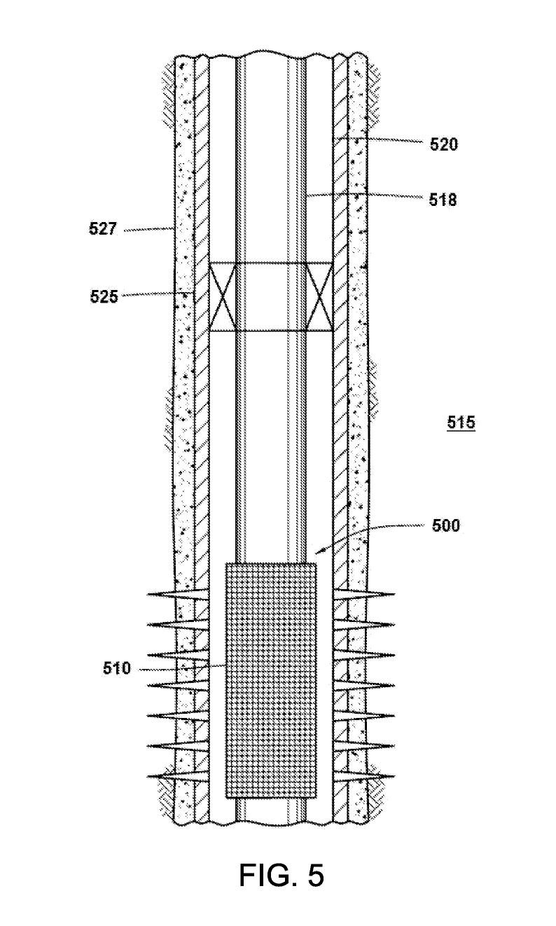

Referring now to FIG. 5, with continued reference to FIG. 1, illustrated is a downhole tool 100 (FIG. 1) shown as a well screen tool 500, that may be composed wholly or partially (i.e., a component thereof) of the cellulosic derivatives described herein. As depicted, the well screen tool 500 is disposed in a wellbore 520 in a subterranean formation 515, which may be substantially similar to the well system 110 in FIG. 1. In the depicted embodiment, the wellbore 520 may be lined with a casing 525 that may be wholly or partially cemented in place with cement 527 in the wellbore 520. The well screen tool 500 comprises a well screen 510 suspended from a tool string 518. The well screen 510 may be used in a variety of subterranean formation operations including, but not limited to excluding sand and formation fines from fluids produced from the subterranean formation 520, excluding gravel forming a gravel pack from fluids produced from the subterranean formation 520, and the like.

In operation, the well screen 510 may be characterized as having multiple perforations in any configuration and size that permit produced fluids or other desirable fluids to flow therethrough, while preventing sand, fines, gravel, or other particulates from entering into the interior of the well screen 510. The well screen 510 may be further characterized as having one or more flow channels between a filter and the interior of the tool string 518. In some embodiments, the well screen 510 may be wholly made of a degradable cellulosic derivative. In other embodiments, the perforations may be made of a degradable cellulosic derivative such that the perforations are effectively sealed by the degradable cellulosic derivative until the cellulosic derivative is degraded in a wellbore environment, thus opening the perforations. Such a configuration may be desired to ensure that the well screen 510 remains impenetrable during a particular operation (e.g., a gravel packing operation) and after completion or a time after completion of the particular operation, the perforations on the well screen 510 permit fluid flow therethrough. This configuration may serve as an additional failsafe to exclude particulates from entering into the interior of the well screen 510.

The downhole tool or components thereof may be formed wholly or partially by a degradable cellulosic derivative. The cellulosic source of the cellulosic derivative may be derived from any suitable source including, but not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), recycled cellulose, and the like, and any combination thereof. The cellulosic source for the degradable cellulosic derivatives described for use in the embodiments herein may have the general structure according to Structure I below:

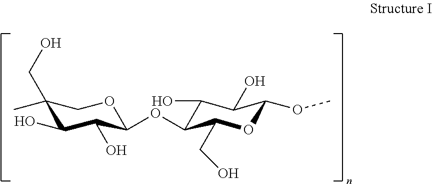

Structure 1 may thus be represented by the formula (C₆H₁₀C₅)ₙ, wherein n is an integer ranging from a lower limit of about 10, 100, 1000, 5000, 10000, 25000, 30000, 35000, 40000, 45000, and 50000 to an upper limit of about 100000, 95000, 90000, 85000, 80000, 75000, 70000, 65000, 60000, 55000, and 50000, encompassing any value and subset therebetween. A cellulosic derivative derived from a cellulosic source with a lower “n” integer, without being bound by theory, will exhibit a greater rate of degradation.

In some embodiments, the hydroxyl groups (—OH groups) of Structure I may be partially or fully reacted with one or more reagents that may result in partial or complete substitution of the hydroxyl group with another group (—OR) to afford the cellulosic derivatives additional properties (e.g., rigidity, elasticity, frangibility, and the like) for use in forming the downhole tools or components thereof described herein.

Reagents suitable for partial or full reaction with the hydroxyl groups of Structure I for forming the cellulosic derivatives described herein may include, but are not limited to, acetic acid, acetic anhydride, propanoic acid, butyric acid, nitric acid, a nitrating agent, sulfuric acid, a sulfuring agent, a halogenoalkane (e.g., chloromethane, chloroethane, and the like), an epoxide (e.g., ethylene oxide, propylene oxide), a halogenated carboxylic acid (e.g., chloroacetic acid), and the like, and any combination thereof.

In some embodiments, the general structure of a cellulosic derivative for use in the embodiments described herein may, in some embodiments, exhibit the general structure according to Structure II below:

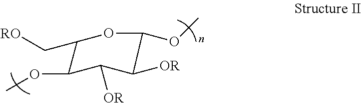

wherein R is one or a combination of —(C═O)CH₃, —(C═O)CH₂CH₃, —(C═O)CH₂CH₂CH₃, —NO₂, —SO₃H, —CH₃, —CH₂CH₃, —CH₂CH₂OH, —CH₂CH(OH)CH₃, —CH₂COOH, —H, and any combination thereof. In some embodiments, at least one R in Structure II is a hydrogen (—H).

In some embodiments, for example, suitable specific cellulosic derivatives for use in the embodiments described herein may include, but are not limited to, cellulose esters, cellulose ethers, and the like, and any combination thereof.

In some embodiments, the oxidation of the cellulosic derivatives (e.g., oxidized cellulose esters used in accordance with the embodiments described herein) may be measured by determining the acid number of the cellulosic derivative. The acid number is defined as the milligrams of base required to neutralize 1 gram of the cellulosic derivative, as described in the American Society of Testing and Materials D974-14. The acid number may be set by the intended end use application of the cellulosic derivative (e.g., the particular downhole tool or component thereof in which it is included), and thus a broad acid number may be applicable. In some embodiments the acid number of the cellulosic derivative may be in the range of from a lower limit of about 1, 10, 20, 30, 40, 50, 60 and an upper limit of about 130, 120, 110, 100, 90, 80, 70, and 60, encompassing any value and subset therebetween, such as from about 30 to about 130, from about 30 to about 90, and the like.

The cellulosic derivatives of the present disclosure for use in forming a downhole tool or component thereof may further have a degree of substitution. As used herein, the term “degree of substitution” (or “DS”) refers to the average number of substituent groups (e.g., acyl substituent groups) attached per monomeric unit of the polymer. Advantages of using degree of substitution to characterizing cellulosic derivatives include its universal usage where a DS of 1 equates to one of the three hydroxyl groups being substituted (accordingly, a DS of 3 equates to three hydroxyl groups being substituted) and DS can be easily measured by widely available and acceptable analytical methodologies, as described below. In some embodiments, the cellulosic derivatives may have a DS in the range of between about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, and 3.0, encompassing any value and subset therebetween. The DS may depend on the technique that is used for measuring the DS. Proton nuclear magnetic resonance (NMR) (also referred to as H-NMR) is a common and preferred method for measuring the DS and relies on determining the amount of glucose monomer by integration of the backbone region of the cellulosic derivative, which is then divided by seven (7), which is the number of protons normally attached to the glucose monomer. However, oxidation of the glucose monomer will reduce the number of protons depending upon the extend of oxidation. Hence, if no hydrolysis of the substituents occur, normal NMR methods will produce a DS that will increase linearly with oxidation. If hydrolysis of the substituents is occurring, the increase in DS will not be linear. Accordingly, proton NMR may provide an indication of oxidation. In some embodiments, the DS may be between about 0.5 and 1.3, between about 0.5 and 2.8, between about 1.5 and 2.5, between about 1.7 and 2.7, or other ranges, without departing from the scope of the present disclosure. The DS values described herein may be determined using H-NMR, or other known methods.

Referring now to the cellulose esters that may be used as the cellulosic derivative forming the downhole tool and/or components thereof of the present disclosure, such cellulose esters may be organic cellulose esters, inorganic cellulose esters, and the like, and any combination thereof. Specific examples of suitable organic cellulose esters may include, but are not limited to, cellulose acetate, cellulose diacetate, cellulose triacetate, cellulose propionate, cellulose acetate propionate, cellulose acetate butyrate, and any combination thereof. Suitable inorganic cellulose esters may include, but are not limited to, nitrocellulose, cellulose sulfate, and the like, and any combination thereof. As described above, the cellulosic derivatives may have thermoplastic properties, allowing for example formation of the downhole tool or component thereof by certain processes, such as melt processing, as described in detail below. Additionally, in some embodiments, the cellulosic derivative may be compounded with a thermoplastic elastomer in order to combine the degradation properties of the cellulose with the elastomeric properties of the thermoplastic, as described herein.

Longer chain cellulose esters may also be used in the embodiment described herein as the cellulosic derivative forming the downhole tool or component thereof. For example, suitable long-chain cellulose esters may have a substituent having the formula (C═O)(CH₂)_{y}CH₃, where y>2 such that the number of carbon atoms is described as an acyl substituent size. In some embodiments, the number of carbon atoms may be such that y>3, y>4, y>5, y>6, y>7, y>8, y>9, y>10, y>11, or even higher, encompassing any value or subset therebetween. In some embodiments, y may accordingly be between about 2 and about 11, or even higher if feasibly able to be manufactured. Without being limited by theory, the greater the number of carbon atoms, the greater the ability of the downhole tool or component thereof to withstand mechanical and environmental demands within a wellbore while the downhole tool or component thereof is in operation until such time as the degradation (i.e., self-removing) properties of the cellulosic derivative is required. It is believed that the increased number of carbon atoms (i.e., the size of the acyl substituent) increase both the melting point and glass transition temperature of the cellulose esters, as described further below.

In general, the cellulose esters for use as the cellulosic derivatives described herein may have a weight average molecular weight (Mw) in the range of a lower limit of about 5,000; 20,000; 40,000; 60,000; 80,000; 100,000; 120,000; 140,000; 160,000; 180,000; and 200,000 to an upper limit of about 400,000; 380,000; 360,000; 340,000; 320,000; 300,000; 280,000; 260,000; 240,000; 220,000; and 200,000, encompassing any value and subset therebetween. Without being limited, in some embodiments, the Mw of the cellulose esters may range from about 5,000 to about 400,000, or from about 10,000 to about 300,000, or about 25,000 to about 250,000, without departing from the scope of the present disclosure. The Mw values described herein may be determined using gel permeation chromatography (GPC), or other known methods.

In some embodiments, the cellulose esters for use as the cellulosic derivatives forming the downhole tool or component thereof may have at least one melting point (Tm) of greater than about 60° C., 80° C., 100° C., 120° C., 140° C., 160° C., 180° C., 200° C., 220° C., 240° C., 260° C., 280° C., 300° C., 320° C., 340° C., 360° C., 380° C., 400° C., 420° C., 440° C., 460° C., 480° C., 500° C., 520° C., 540° C., 560° C., or even greater, encompassing any value and subset therebetween. For example, in some embodiments, the melting point of the cellulose esters may be such that it can be used in subterranean formation operations utilizing steam (e.g., enhanced oil recovery with steam, or other operations employing steam). It may be, in certain embodiments, preferred that the cellulose ester have a high Tm, because without being limited by theory, it is believed that the Tm may relate to the downhole tool's or component's thereof ability to withstand mechanical and environmental demands within a wellbore while the downhole tool or component thereof is in operation until such time as the degradation (i.e., self-removing) properties of the cellulosic derivative is required.

In another embodiment, the cellulose esters for use as the cellulosic derivatives forming the downhole tool or component thereof may have at least one glass transition temperature (Tg) of greater than about 60° C., 70° C., 80° C., 90° C., 100° C., 110° C., 120° C., 130° C., 140° C., 150° C., 160° C., 170° C., 180° C., 190° C., 200° C., or even greater, encompassing any value and subset therebetween. Like the acyl substituent size and the melting point, it is believed that the greater the Tg of the cellulose ester, without being limited by theory, the greater the ability of the downhole tool or component thereof to withstand mechanical and environmental demands within a wellbore while the downhole tool or component thereof is in operation until such time as the degradation (i.e., self-removing) properties of the cellulosic derivative is required.

The cellulose esters used for forming the downhole tool or component thereof may be commercially available from Eastman Chemical Company in Kingsport, Tenn., or Celanese Corporation in Irving, Tex. Examples of suitable cellulose esters from Eastman Chemical Company for use in forming the downhole tool or component thereof may include, but are not limited to, TENITE™ cellulose acetate, TENITE™ cellulose acetate butyrate, TENITE™ cellulose acetate propionate, and combinations thereof. Examples of suitable cellulose esters from Celanese Corporation for use in forming the downhole tool or component thereof may include, but are not limited to, CELAIRE™ cellulose acetate in flake, fiber, tow, and/or non-woven forms; CELFX™ cellulose acetate in matrix form; CLAREFLECT™ cellulose acetate in film form; CLAREFOIL™ cellulose acetate in film form; and any combination thereof.

In some embodiments of the present disclosure, where the cellulosic derivative selected is a cellulose ester, the downhole tool or component thereof may comprise a one or more cellulose esters that are partially or completely substituted with one or more substituents (e.g., acyl substituent, and the like), one or more cellulose esters having greater than one Tm, one or more cellulose esters having greater than one Tg, and any combination thereof. That is, a single cellulose ester may be used having a range of substitutions, Tm's, and Tg's (e.g., differing Tg transitions may be found with differing transition phases). In yet other embodiments, the downhole tool or component thereof may comprise greater than one type of cellulose ester, and, moreover, may comprise additional cellulosic derivatives, other degradable materials, or other non-degradable materials, without departing from the scope of the present disclosure.

As described above, in some embodiments, the cellulosic derivatives may exhibit adhesive properties for use in forming a downhole tool or component thereof, such as a connection component holding one or more other components together. For example, it may replace the need for a screw, keys, pin, spring, or other connection component. Additionally, the cellulosic derivatives displaying adhesive properties may be used as a component of the downhole tool to holds another component in place and later be released upon degradation (e.g., a ball seat, an actuator, a latch, and the like) or as an actuator control device that actuates an actuator upon being degraded.

The cellulosic derivative may be adhesive in nature when the cellulosic derivative selected is a cellulose ester that comprises a cellulose polymer backbone comprising an organic ester substituent and an inorganic ester substituent, wherein the inorganic ester substituent comprises an inorganic, non-metal atom selected from the group consisting of sulfur, phosphorus, boron, or chlorine. Accordingly, the term “inorganic ester substituent” refers to an ester wherein the ether linkage of the ester comprises an oxygen bound to an R group and an inorganic, nonmetal atom (e.g., sulfur, phosphorus, boron, and chlorine). It should be noted that inorganic esters encompass esters derived from oxoacids that comprise both inorganic, nonmetal atoms and carbon atoms (e.g., alkyl sulfonic acids, such as methane sulfonic acid).

As used herein, the term “adhesive cellulosic derivative” refers to such cellulose esters described above comprising the organic ester substituent and the inorganic ester substituent, wherein the inorganic ester substituent comprises an inorganic, non-metal atom selected from the group consisting of sulfur, phosphorus, boron, or chlorine.

In some embodiments, the organic ester substituent of the cellulosic derivative may include, but is not limited to, C₁-C₂₀ aliphatic esters (e.g., acetate, propionate, or butyrate), aromatic esters (e.g., benzoate or phthalate), substituted aromatic esters, and the like, any derivative thereof, and any combination thereof. The degree of substitution of the organic ester substituent may be in the range of from a lower limit of about 0.2, 0.5, or 1 to an upper limit of less than about 3, about 2.9, 2.5, 2, or 1.5, encompassing any value and subset therebetween. In some embodiments, the DS may be between about 0.2 and about 3, encompassing any value and subset therebetween.

The inorganic ester substituent of the adhesive cellulosic derivative may include, but is not limited to, hypochlorite, chlorite, chlorate, perchlorate, sulfite, sulfate, sulfonates (e.g., taurine, toluenesulfonate, C₁-C₁₀ alkyl sulfonate, aryl sulfonate, and the like), fluorosulfate, nitrite, nitrate, phosphite, phosphate, phosphonates, borate, and the like, any derivative thereof, and any combination thereof.

In some embodiments, the weight percent of the inorganic, nonmetal atom of the inorganic ester substituent of an adhesive cellulosic derivative described herein may range from a lower limit of about 0.01%, 0.05%, or 0.1% to an upper limit of about 8%, 5%, 3%, 1%, 0.5%, 0.25%, 0.2%, or 0.15%, encompassing any value and subset therebetween. In some embodiments, the inorganic ester substituent may be between about 0.01% to about 1%, encompassing any value and subset therebetween.

The adhesive properties of the adhesive cellulosic derivative described herein may have a relationship to, among other things, the cellulosic source from which it was derived. Without being limited by theory, it is believed that certain components, for example, lignin and hemicelluloses, and concentrations thereof in the various cellulosic sources contribute to the differences in adhesive properties of the adhesive cellulosic derivative derived therefrom. By way of nonlimiting example, a softwood may yield an adhesive cellulosic derivative with higher binding strength as compared to an adhesive cellulosic derivative derived from a hardwood.

The adhesive cellulosic derivatives described herein, and consequently the downhole tool or component thereof produced therefrom, may be degradable as described herein. Without being limited by theory, it is believed that at least some inorganic ester substituents may be more susceptible to catalytic hydrolysis than a corresponding cellulose ester that does not comprise (or minimally comprises) inorganic ester substituents. Further, after some inorganic ester substituents undergo hydrolysis, a strong acid may be produced, which may further speed degradation.

In some embodiments, an adhesive cellulosic derivative suitable for use in forming the downhole tools or components thereof described herein may further comprise a solvent. Suitable solvents for use in conjunction with an adhesive cellulosic derivative may include, but are not limited to, water, acetone, methanol, ethanol, methylethyl ketone, methylene chloride, dioxane, dimethyl formamide, tetrahydrofuran, acetic acid, dimethyl sulfoxide, N-methyl pyrrolidinone, dimethyl carbonate, diethyl carbonate, ethylene carbonate, propylene carbonate, and the like, any derivative thereof, and any combination thereof. The choice of solvent may, depend on, among other things, the degree of substitution and the amount of inorganic, nonmetal atom of the methylethyl ketone.

By way of nonlimiting example, an adhesive cellulosic derivative described herein may comprise at least one substituted cellulose ester having an organic ester substituent degree of substitution of greater than about 0 to about 1, an aqueous solvent, and optionally an organic solvent. By way of another nonlimiting example, an adhesive cellulosic derivative described herein may comprise at least one substituted cellulose ester having an organic ester substituent degree of substitution of about 0.7 to about 2.7 and a mixed solvent that comprises an aqueous solvent and an organic solvent (e.g., acetone). By way of yet another nonlimiting example, an adhesive cellulosic derivative described herein may comprise at least one substituted cellulose ester having an organic ester substituent degree of substitution of about 2.4 to less than about 3, an organic solvent (e.g., acetone), and optionally an aqueous solvent at about 15% or less by weight of the organic solvent.

In some embodiments, an adhesive cellulosic derivative suitable for use in forming the downhole tools or components thereof described herein may be substantially formaldehyde-free, which may also be described as “an adhesive cellulosic derivative with no added formaldehyde.” In some embodiments, an adhesive cellulosic derivative for use in forming the downhole tools or components thereof described herein may comprise less than about 0.01% formaldehyde by weight of the substituted cellulose acetate of the adhesive cellulosic derivative.

Referring now to cellulose ethers for use as the cellulosic derivatives for forming the downhole tools or components thereof described herein, the cellulose ethers may be alkyl cellulose ethers, hydroxyalkyl cellulose ethers, carboxyalkyl cellulose ethers, and the like, and any combination thereof. Specific examples of suitable cellulose ethers may include, but are not limited to, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose, and the like, and any combination thereof.

The cellulose ethers used for forming the downhole tool or component thereof may be commercially available from Dow Chemical Company in Midland, Mich. (e.g., METHOCEL™, ETHOCEL™, WELLENCE™, CLEAR+STABLE™, and FORTFIBER™).

In some embodiments, the cellulosic derivatives described herein, regardless of their type (e.g., cellulose ester, cellulose ether, and the like), may further comprise an additive selected from the group consisting of a plasticizer, a pigment, a modifier, a tackifier, a lubricating agent, an emulsifier, an antimicrobial agent, an antistatic agent, a crosslinker, an indicator (e.g., a pigment or colorant that signals dissolution), a stabilizer, an antioxidant, a wax, an insolubilizer, a water-resistant additive, a flame retardant, a softening agent, an antifungal agent, an elastomer, a thermoplastic, and the like, and any combination thereof.

Without being limited by theory, it is believed that the plasticizer may reduce the Tg of the cellulosic derivative to achieve a desired balance between proccessability and desired properties (e.g., rigidity, elasticity, etc.) of the downhole tool or component thereof comprising the plasticized cellulosic derivative. Examples of suitable plasticizer additives may include, but are not limited to, a glycol, an adipic ester, a citrate ester, a phthalate ester, a carbohydrate ester, a polyol ester, an epoxidized vegetable oil, a glycerin, a polymeric plasticizer, and the like and any combination thereof.

Specific examples of suitable plasticizers may include, but are not limited to, diethylhexyladipate, dibutyl phthalate, dibutyl adipate, diethyl phthalate, diisobutyl adipate, diisononyl adipate, dioctyl adipate, n-butyl benzyl phthalate, 1,3-butylene glycol/adipic acid polyester, tricresyl phosphate, benzyl benzoate, triphenyl phosphate, butyl stearate, triethyl citrate, tributyl citrate, tributyl acetyl citrate, camphor, epoxidized soybean oil, propylene glycol adipate, 2,2,4-trimethyl-1,3-pentanediol diisobutyrate (TXIB), 2-amino-2-methyl propanol, dibutyl sebacate, dimethicone copolyol, polyethylene glycol-6 capric/caprylic glyceride, phenyl trimethicone, propylene glycol, dipropylene glycol, glycerol triacetate, dimethoxy-ethyl phthalate, dimethyl phthalate, methyl phthalyl ethyl glycolate, o-phenyl phenyl-(bis)phenyl phosphate, 1,4-butanediol diacetate, diacetate, dipropionate ester of triethylene glycol, dibutyrate ester of triethylene glycol, dimethoxyethyl phthalate, triacetyl glycerin, and the like, any derivative thereof, any in combination with water, and any combination thereof. As used herein, the term “derivative” (alone, rather than a “cellulosic derivative”) refers to any compound that is made from one of the listed compounds, for example, by replacing one atom in one of the listed compounds with another atom or group of atoms, ionizing one of the listed compounds, or creating a salt of one of the listed compounds.

In some embodiments, the cellulosic derivatives described herein may further comprise a plasticizer in an amount in the range of a lower limit of about 0.1%, 0.5%, 1%, 5%, 10%, 15%, 20%, 25%, 30%, and 35% to an upper limit of about 70%, 65%, 60%, 55%, 50%, 45%, 40%, and 35% by the combined weight of the cellulosic derivative and any additives included therewith, encompassing any value and subset therebetween. It should be noted that selection of the proper plasticizer and the amount of plasticizer is based upon the compatibility of the plasticizer with the cellulosic derivative (e.g., cellulose ester) and on the desired properties in the finished downhole tool and/or component thereof. In this regard, it is important to note that the compatibility of each plasticizer will vary with each cellulosic derivative. As an example, dioctyl adipate has poor compatibility with cellulose acetates, but good compatibility with most cellulose acetate butyrates. Those of average skill in the art, with the benefit of this disclosure, will recognize the type and amount of optimization plasticizer type(s), loading, and method of incorporation for particular cellulosic derivatives and downhole tool and/or component types.

In some embodiments, the cellulosic derivatives described herein may further comprise a pigment additive to impart a particular color or hue to the downhole tools or components thereof comprising the cellulosic derivatives. As used herein, the term “pigment” or “pigment additive” (which also may be referred to herein as a colorant) refers to a substance (e.g., particle, compound, and the like) that imparts color and is incorporated throughout another substance (e.g., the cellulosic derivative), or that imparts color and behaves as a surface treatment atop another substance (e.g., the cellulosic derivative).

Such color or hue may be beneficial in making certain components of the downhole tool readily identifiable for various reasons (e.g., for brand recognition, for safety requirements, and the like). Suitable pigment additives may include, but are not limited to, titanium dioxide, silicon dioxide, tartrazin (e.g., E102), phthalocyanine blue, phthalocyanine green, a quinacridone, a perylene tetracarboxylic acid di-imide, a dioxazine, a perinone, a disazo, an anthraquinone, carbon black, a metal powder, iron oxide, ultramarine, calcium carbonate, kaolin clay, aluminum hydroxide, barium sulfate, zinc oxide, aluminum oxide, and the like, and any combination thereof. The amount of pigment additive may depend on the desired color and saturation for a particular cellulosic derivative, or the downhole tool or component comprising the cellulosic derivative. Suitable commercially available pigment additives may include, but are not limited to, a CARTASOL® Dyes, cationic dyes in liquid and/or granular form available from Clariant in Muttenz, Switzerland (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid, and the like) and FASTUSOL® Dyes, an auxochrome available from BASF SE in Ludwigshafen, Germany (e.g., Yellow 3GL, Fastusol C Blue 74L).

In some embodiments, although it does not substantially, if at all, affect the function of the downhole tool and/or component thereof or its degradability, the pigment additive may be included in an amount in the range of from a lower limit of about 0.01%, 0.1%, 0.5%, 1%, 2.5%, 5%, 7.5%, and 10% to an upper limit of about 30%, 27.5%, 25%, 22.5%, 20%, 17.5%, 15%, 12.5%, and 10% by the combined weight of the cellulosic derivative and any additives included therewith, encompassing any value and subset therebetween.

Modifier additives may be included in the cellulosic derivatives disclosed herein for forming the degradable downhole tools or components therein to alter the properties of the cellulosic derivatives, such as to increase toughness, molecular weight, strength, elongation, flexibility, mechanical integrity, chemical integrity, and/or property consistency and uniformity. The modifier additives may additionally improve mixing, dispersion, wetting, and/or adhesion of the cellulosic derivatives to itself or other substances during formation (i.e., fabrication) and use of the downhole tool or component thereof. Examples of suitable modifier additives may include, but are not limited to, a weighting agent, a reinforcing agent, a polymeric modifier, and the like and any combination thereof.

In some embodiments, the modifier may be a weighting agent that serves as a filler material. The weighting agent may be used to increase the density of the cellulosic derivative, which may, among other things, increase the abrasion resistance of the cellulosic derivative for use in forming the downhole tool or component thereof. In other embodiments, the weighing agent may be used to decrease the density of the cellulosic derivative, which may, among other things, allow the cellulosic derivative to be neutral density in a wellbore fluid. Suitable weighting agents may include, but are not limited to, barite, precipitated barite, submicron precipitated barite, hematite, ilmentite, manganese tetraoxide, galena, calcium carbonate, hausmannite ore, hollow glass spheres, ceramic agents, and the like, and any combination thereof. Suitable commercially available weighting agents may include, but are not limited to MICROMAX® Weight Additives, a hausmannite ore weighting agent available from Halliburton Energy Services, Inc. in Houston, Tex. (e.g., MICROMAX® FF, and the like). In some embodiments, the weighting agent may be present in an amount in the range of from a lower limit of about 5%, 10%, 15%, 20%, 25%, 30%, 35%, and 40% to an upper limit of about 80%, 75%, 70%, 65%, 60%, 55%, 50%, 45%, and 40% by the combined weight of the cellulosic derivative and any additives included therewith, encompassing any value and subset therebetween.

The cellulosic derivatives described herein may further comprise a modifier additive in the form of a reinforcing agent additive. The reinforcing agent may include a solid particulate that may increase the mechanical integrity of the cellulosic derivatives, such as to elevated temperatures, elevated pressures, and the like, in a downhole environment, thereby prolonging the degradation rate of the cellulosic derivative. The solid particulate reinforcing agents may be in any shape including, but not limited to, spherical-shaped, rod-shaped, fiber-shaped, flake-shaped, thin-film shaped, amorphous-shaped, and the like, and any combination thereof. Suitable reinforcing agents may be composed of a material including, but not limited to, a mineral, a metal, a polymer, a plastic, a salt, a glass, a comminuted plant material, and the like, and any combination thereof. Moreover, the reinforcing material may be itself degradable (or non-degradable).

Examples of suitable specific reinforcing agent materials may include, but are not limited to, nylon, rayon, glass, silicon, graphite, graphene, nanoparticles, petroleum coke, starch, crystalline polylactic acid, semi-crystalline polylactic acid, calcium carbonate, sodium chloride, aluminum silicate, calcium sulfate, calcium chloride, solid anhydrous borate materials, magnesium oxide, talc, silicate, mica, carbon black, carbon fiber, carbon nanotube, wollastonite, an alkali metal, an alkaline earth metal, a transition metal, a post-transition metal, a metalloid, coconut shell flour, walnut shell flour, a wood substrate, wood flour, wheat flour, soybean flour, gum, zeolite, protein materials, a thickening material, rigid compounds (e.g., lignin), and the like, and any combinations thereof. Suitable plant material for forming the comminuted plant material reinforcing agents may include, but are not limited to, nut and seed shells or hulls of almond, brazil, cocoa bean, coconut, cotton, flax, grass, linseed, maize, millet, oat, peach, peanut, rice, rye, soybean, sunflower, walnut, and wheat; rice tips; rice straw; rice bran; crude pectate pulp; peat moss fibers; flax; cotton; cotton linters; wool; sugar cane; paper; bagasse; bamboo; corn stalks; sawdust; wood; bark; straw; cork; dehydrated vegetable matter; whole ground corn cobs; corn cob light density pith core; corn cob ground woody ring portion; corn cob chaff portion; cotton seed stems; flax stems; wheat stems; sunflower seed stems; soybean stems; maize stems; rye grass stems; millet stems; and the like; and any combination thereof.

In some embodiments, when the solid reinforcing material is substantially spherical, it may have an average size in the range from a lower limit of about 1 nanometer (nm), 100 nm, 500 nm, 1000 nm, 2000 nm, 4000 nm, 6000 nm, 8000 nm, 0.01 millimeters (mm), 0.05 mm, 0.1 mm, 0.15 mm, 0.2 mm, 0.25 mm, and 0.3 mm to an upper limit of about 1 mm, 0.95 mm, 0.9 mm, 0.85 mm, 0.8 mm, 0.75 mm, 0.7 mm, 0.65 mm, 0.6 mm, 0.55 mm, 0.5 mm, 0.45 mm, 0.4 mm, 0.35 mm, 0.3 mm, encompassing any value and subset therebetween. Where the solid reinforcing material is substantially non-spherical (e.g., fiber-shaped, rod-shaped, and the like), it may have an aspect ratio of a lower limit of about 2:1, 3:1, 4:1, 5:1, 6:1, 7:1, 8:1, 9:1, and 10:1 to an upper limit of about 20:1, 19:1, 18:1, 17:1, 16:1, 15:1, 14:1, 13:1, 12:1, 11:1, and 10:1, encompassing any value and subset therebetween. Substantially non-spherical shaped reinforcing material may also be sized such that the average longest axis has a length in the range of a lower limit of about 0.0001 mm, 0.001 mm, 0.01 mm, 0.1 mm, 0.2 mm, 0.3 mm, 0.4 mm, 0.5 mm, 0.6 mm, 0.7 mm, 0.8 mm, 0.9 mm, 1 mm, 1.25 mm, 1.5 mm, 1.75 mm, 2 mm, 2.25 mm, 2.5 mm, 2.75 mm, 3 mm, 3.25 mm, 3.5 mm, 3.75 mm, and 4 mm to an upper limit of about 10 mm, 9.75 mm, 9.5 mm, 9.25 mm, 9 mm, 8.75 mm, 8.5 mm, 8.25 mm, 8 mm, 7.75 mm, 7.5 mm, 7.25 mm, 7 mm, 6.75 mm, 6.5 mm, 6.25 mm, 6 mm, 5.75 mm, 5.5 mm, 5.25 mm, 5 mm, 4.75 mm, 4.5 mm, 4.25 mm, and 4 mm, encompassing any value and subset therebetween. Without being limited by theory, it is believed that smaller reinforcing agents may provide better strength reinforcement to the cellulosic derivative as they may more easily be dispersed therein.

The cellulosic derivatives described herein may comprise a modifier additive in the form of a polymeric modifier. Such polymeric modifiers may modify the cellulosic derivative in a number of ways, without being bound by theory, including, but not limited to, impact modification, compatibility modification, coupling agent modification, adhesion promotion modification, and the like, and any combination thereof between the cellulosic derivative and another component thereof (e.g., an additive as described herein). The polymeric modifiers may include, but are not limited to, as described herein and in detail below, a modified polymer, a modified hydrocarbon, a low molecular weight compound having reactive polar groups, and the like, and any combination thereof. In some embodiments herein, the cellulosic derivative may comprise a single type of polymeric modifier, multiple polymeric modifiers of the same type, or multiple polymeric modifiers of two or more different types, without departing from the scope of the present disclosure.

In some embodiments, the polymeric modifiers may modify only the cellulosic derivative. In other embodiments, the polymeric modifiers may modify the cellulosic derivative and/or a polymeric component included therein, such as an additive including, but not limited to, a polymeric weighting agent, a polymeric wax, a polymeric reinforcing agent (e.g., a polymeric fiber), a polymeric film (e.g., a thin polymeric material in the shape of a thin film where the thinness of the film may accelerate degradation, for example), and the like, and any combination thereof. In other embodiments, the polymeric modifiers may modify the cellulosic derivative and/or a polymeric component therein and/or a non-polymeric component therein, such as an additive including, but not limited to, a non-polymeric weighting agent, a non-polymeric reinforcing agent, a non-polymeric pigment additive, a non-polymeric stabilizer, a non-polymeric antioxidant, and the like, and any combination thereof.

Polymeric impact modifiers may improve the overall toughness of the cellulosic derivatives described herein. For example, under optimal dispersion, a rubbery phase of one or more polymeric impact modifiers may help improve impact strength and elongation. The polymeric impact modifiers may further provide enhanced ductility in blended cellulosic derivatives (e.g., with polyamides or other polymers) at low temperatures, such as those below about −40° C. without compromising or substantially compromising desirable heat resistance. The polymeric compatibility modifiers may increase interphase adhesion and achieve compatibility between the cellulosic derivative itself and/or many polar polymers and polyolefins. Polymeric coupling agent modifiers may promote chemical bonding between other modifiers (e.g., reinforcing agents, weighting agents, and the like) and the cellulosic derivative or other materials (e.g., polymers) forming the downhole tool or component thereof, as described herein. When the cellulosic derivative is non-polar or non-polar polymer constituents are used in forming the downhole tool or component thereof, the polymeric adhesion promoter modifiers may enhance adhesion to certain substrates, such as the weighting agents or reinforcing agents described herein, including but not limited to, metals, rubbers (e.g., thermoset rubbers), polar substrates, glass, ceramics, composites, and the like.

In some embodiments, the polymeric modifiers of the present disclosure may be a modified polymer (e.g., a functionalized polymer, such as a functionalized polyolefin). Examples of suitable modified polymers for use as the polymeric modifiers described herein may include, but are not limited to, a polypropylene, a functionalized polyethylene homopolymer, a copolymer that has been modified with carboxylic acid groups, a copolymer that has been modified with anhydride groups, a modified olefin polymer (e.g., a graft copolymer and/or block copolymer, such as a propylene-maleic anhydride graft copolymer), and the like, and any combination thereof. Suitable groups used to modify the modified polymers may include, but are not limited to, an acid anhydride, a carboxylic acid, a carboxylic acid derivative, a primary amine, a secondary amine, a hydroxyl compound, oxazoline and an epoxide, an ionic compound, an unsaturated cyclic anhydride, an aliphatic diester of an unsaturated aliphatic diester, a diacid derivative of an unsaturated cyclic anhydride, and the like, and any combination thereof. Specific examples of modified polymers for use as polymeric modifiers may include, but are not limited to, maleic anhydride and compounds selected from C₁-C₁₀ linear and branched dialkyl maleates, C₁-C₁₀ linear and branched dialkyl fumarates, itaconic anhydride, C₁-C₁₀ linear and branched itaconic acid dialkyl esters, maleic acid, fumaric acid, itaconic acid, and the like, and combinations thereof.

Suitable commercially available modified polymers for use as the polymeric coupling agent may include, but are not limited to, LICOCENE® or LICOLUBE®, metallocene polymers and esters of montanic acids, respectfully, available from Clariant in Muttenz, Switzerland (e.g., LICOCENE® 6452, LICOCENE® 4351, and the like); A-C™ Performance Additives, styrenic block copolymer, metallocene polyolefin, amorphous poly-alpha-olefin, polyamide, and ethylene vinyl acetate polymers available from Honeywell International, Inc. in Morristown N.J. (e.g., AC-575™, an ethylene maleic anhydride copolymer, AC-392™ and AC-395™, high density oxidized polyethylenes, and the like); CERAMER™ Polymers, grafted maleic anhydride derivatives onto hydrocarbon polymers available from Baker Hughes Incorporated in Houston, Tex.; EXXELOR™ Polymer Resins, functionalized elastomeric and polyolefinic polymers available from ExxonMobil Corporation in Irving, Tex.; and EPOLENE® Polymers, medium to low molecular weight polyethylene or polypropylene polymers available from Westlake Chemical Corporation in Houston, Tex.

In some embodiments, the modified polymer for use as the polymeric modifier described herein may be present in an amount in the range of a lower limit of about 5%, 6%, 7%, 8%, 9%, and 10% to an upper limit of about 15%, 14%, 13%, 12%, 11%, and 10% by the combined weight of the cellulosic derivative and any additives included therewith, encompassing any value and subset therebetween. The modified polymer may also have an acid number having a lower limit of about 0.1, 1, 5, 10, 15, 20, 25, 30, 35, 40, 45, and 50 to an upper limit of about 100, 95, 90, 85, 80, 75, 70, 65, 60, 55, and 50. The acid number may be determined by any standard methodology, such as the American Society for Testing and Materials International (ASTM) (e.g., ASTM D-1386-10), or any other method known in the art (e.g., Fourier transform infrared spectroscopy), and may refer to an amount of base in milligrams per gram of polymer required to neutralize acid functionality when measured by titration. Additionally, in some embodiments, the modified polymer for use as the polymeric modifier in the cellulosic derivative forming a degradable downhole tool or component therein may have a melt viscosity of less than about 80,000 centipoise (cP) at 150° C., less than about 40,000 cP at 150° C., less than about 20,000 cP at 150° C., less than about 10,000 cP at 150° C., less than about 5,000 cP at 150° C., less than about 1,000 cP at 150° C., less than about 500 cP at 150° C., less than about 100 cP at 150° C., less than about 1 cP at 150° C., or less than about 0.1 cP at 150° C., without departing from the scope of the present disclosure. The melt viscosity of the modified polymer may be determined by standard methodology, such as that provided by the American National Standards Institute (e.g., DIN 53019 (2008)) or the ASTM (e.g., ASTM D-1238-13), or any other method known in the art.

In other embodiments, the polymeric modifier may be a modified hydrocarbon. Such modified hydrocarbons may synergistically enhance performance characteristics of the cellulosic derivative (e.g., mechanical resistance, chemical resistance, and the like), as well as the physical appearance of the cellulosic derivative in forming the downhole tool or component thereof. Such modified hydrocarbons may include, but are not limited to, a functionalized polyethylene, a functionalized polypropylene, a non-functionalized copolymer of ethylene and propylene, and the like, and any combination thereof. Such functionalization may include, but is not limited to, functionalization with maleic anhydride, glycidyl methacrylate, and the like, and any combination thereof. Specific examples of a functionalized polyethylene may include, but are not limited to, maleic anhydride functionalized polyethylene, such as high density polyethylene. Maleic anhydride functionalized polyethylene copolymers, terpolymers and blends may also be used. Maleic anhydride functionality may be incorporated into the polymer by grafting or other reaction methods. When grafting, the level of maleic anhydride incorporation is typically below about 3% by weight of the polymer.

Suitable commercially available modified hydrocarbons may also be used as the polymeric modifiers of the present disclosure. Such commercially available modified hydrocarbons that are maleic anhydride functionalized polyethylenes may include, but are not limited to, AMPLIFY™ Functional Polymers, available from Dow Chemical Company in Midland, Mich. (e.g., AMPLIFY™ GR0204 (anhydride modified polyethylene), a 2,5-Furandione modified ethylene/hexene-1 polymer; BYNEL™ (anhydride modified polyethylene and anhydride modified polypropylene); and FUSABOND™ Resins (maleic anhydride grafted ethylene acrylate carbon monoxide terpolymers, ethylene vinyl acetates (EVAs), polyethylenes, metallocene polyethylenes, ethylene propylene rubbers and polypropylenes) available from E.I. du Pont de Nemours and Company in Wilmington, Del. (e.g., FUSABOND™ E-100, FUSABOND™ E-158, FUSABOND™ E265, FUSABOND™ E528, FUSABOND™ E-589, FUSABOND™ M-603, and the like). Other commercially available maleic anhydride grafted polyethylene polymers, copolymers, and terpolymers may include, but are not limited to, POLYBOND® Polypropylene-Based Coupling Agents from Addivant in Manchester, United Kingdom (e.g., POLYBOND™ 3009, POLYBOND™ 3029, and the like); OREVAC® Grafted Polymers (maleic anhydride modified polyolefins including polypropylene, polyethylene, and ethylene vinyl acetate) available from Arkema in Colombes, France (e.g., OREVAC™ 18510P, and the like); PLEXAR™ Products (maleic anhydride modified polyolefins including polypropylene, polyethylene, and ethylene vinyl acetate) available from LyondellBasell Industries in Rotterdam, South Holland (e.g., PLEXAR™ PX-2049, and the like); YPAREX® Adhesive Resins (maleic anhydride modified polyolefins including polypropylene, polyethylene, and ethylene vinyl acetate) available from Yparex B.V. in Enschede, Netherlands (e.g., YPAREX 8305®, and the like); and EXXELOR™ Polymer Resins (maleic anhydride modified polyolefins including polypropylene and polyethylene) available from ExxonMobil Corporation in Irving, Tex. (e.g., EXXELOR™ PE1040, and the like). Other examples of suitable commercially available modified hydrocarbons for use as the polymeric modifier described herein may include, but is not limited to, LOTADER® 4210, a random terpolymer of ethylene, acrylic ester, and maleic anhydride available from Arkema; and VERSIFY™, propylene-ethylene elastomers available from Dow Chemical Company (e.g., VERSIFY™ 4200, VERSIFY™ 4000, VERSIFY™ 3200, VERSIFY™ 3000, and VERSIFY™ 3300, and the like).

In some embodiments, the modified hydrocarbon for use as the polymeric modifier described herein may be present in an amount in the range of a lower limit of about 0.001%, 0.1%, 0.5%, 1%, 5%, and 10%, to an upper limit of about 35%, 30%, 25%, 20%, 15%, and 10% by the combined weight of the cellulosic derivative and any additives included therewith, encompassing any value and subset therebetween. The modified hydrocarbon may have an acid number in the range of a lower limit of about 0.5, 1, 5, 10, 15, 20, 25, 30, 35, 40, 45, and 50 to an upper limit of about 100, 95, 90, 85, 80, 75, 70, 65, 60, 55, and 50, encompassing any value and subset therebetween. Additionally, in some embodiments, the modified hydrocarbon for use as the polymeric modifier in the cellulosic derivative forming a degradable downhole tool or component therein may have a melt index value in the range of a lower limit of about 0.01, 0.1, 0.5, 1, 5, 10, 15, 20, 25, 30, 35, 40, 45, and 50 to an upper limit of about 100, 95, 90, 85, 80, 75, 70, 65, 60, 55, and 50, encompassing any value and subset therebetween. Melt index values may be determined using a standard methodology, such as that provided by the ASTM (e.g., ASTM D-1238-13), or any other method known in the art, and may be defined by the amount of polymer melt passing in decigrams/minute (or grams/10 minutes) through a heated syringe with a plunger load (e.g., at 190° C. and a 2.16 kilogram load for polyethylene based polymers, and at 230° C. and a 2.16 kilogram load for polypropylene based polymers).

In some embodiments, the polymeric modifier may also be a low molecular weight compound having reactive polar groups. Such low molecular weight compounds having reactive polar groups may have a threshold molecular weight such that the melt index value according to ASTM D-1238-13 is in the range of a lower limit of about 0.01 grams/10 min (g/10 min), 0.1 g/10 min, 0.5 g/10 min, 1 g/10 min, 2 g/10 min, 3 g/10 min, 4 g/10 min, 5 g/10 min, 6 g/10 min, 7 g/10 min, 8 g/10 min, 9 g/10 min, and 10 g/10 min to an upper limit of about 20 g/10 min, 19 g/10 min, 18 g/10 min, 17 g/10 min, 16 g/10 min, 15 g/10 min, 14 g/10 min, 13 g/10 min, 12 g/10 min, 11 g/10 min, and 10 g/10 min at 190° C. and a 2.16 kg load, encompassing any value and subset therebetween.

In some embodiments, the cellulosic derivative may further comprise a tackifier additive. The tackifier may provide improved adhesion and increased stress compliance to enhance bonding strength of the cellulosic derivatives and any additives therewith to other materials. Suitable tackifiers for use in the embodiments described herein may include, but are not limited to, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl)quaternary amines, p-T-amyl-phenols condensed with formaldehyde, dialkyl amino alkyl(meth)acrylates, acrylamides, N-(dialkyl amino alkyl) acrylamide, methacrylamides, hydroxy alkyl(meth)acrylates, methacrylic acids, acrylic acids, hydroxyethyl acrylates, and the like, any derivative thereof, and any combination thereof.

In some embodiments, the tackifier may be present in an amount in the range of from a lower limit of about 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5%, and 4.5%, by the combined weight of the cellulosic derivative and any additives included therewith, encompassing any value and subset therebetween.

In some embodiments, the cellulosic derivative may further comprise a lubricating agent additive. The lubricating agent may provide reduced friction or reduced abrasion. Suitable lubricating agents for use in the embodiments described herein may be water soluble or non-water soluble, and may include, but are not limited to, ethoxylated fatty acids (e.g., the reaction product of ethylene oxide with pelargonic acid to form poly(ethylene glycol) (“PEG”) monopelargonate, the reaction product of ethylene oxide with coconut fatty acids to form PEG monolaurate, and the like), synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

In some embodiments, the lubricating agent may be present in an amount in the range of from a lower limit of about 1%, 2%, 3%, 4%, 5%, 6%, 7%, 8%, 9%, 10%, 11%, 12%, 13%, 14%, and 15% to an upper limit of about 30%, 29% 28%, 27%, 26%, 25%, 24%, 23%, 22%, 21%, 20%, 19%, 18%, 17%, 16%, and 15%, by the combined weight of the cellulosic derivative and any additives included therewith, encompassing any value and subset therebetween.

Another additive suitable for use with the cellulosic derivative described herein may be an emulsifier additive. The emulsifier may provide stabilization of immiscible phases within the cellulosic derivative and any additives included therewith. Suitable emulsifiers may include, but are not limited to, sorbitan monolaurate, poly(ethylene oxide) sorbitan monolaurate, and the like, and any combination thereof. Suitable commercially available emulsifiers may include, but are not limited to, SPAN® 20, a sorbitan monolaurate, and TWEEN® 20, a poly(ethylene oxide) sorbitan monolaurate, both available from Croda International in East Yorkshire, United Kingdom. In some embodiments, the emulsifier may be present in an amount in the range of from a lower limit of about 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5%, and 4.5%, by the combined weight of the cellulosic derivative and any additives included therewith, encompassing any value and subset therebetween.

In yet other embodiments, the cellulosic derivative may further comprise an antimicrobial agent additive. The antimicrobial agent may provide resistance to the microorganisms in a downhole environment (or other environments upstream of introducing the downhole tool or component thereof into a downhole environment), thereby enhancing the integrity of the cellulosic derivative and reducing or eliminating interference with the potential increased degradation rates. Suitable antimicrobial agents may include, but are not limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexaniethylene biguanide (PEHMB)), chlorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

In some embodiments, the antimicrobial agents may be present in an amount in the range of from a lower limit of about 0.001%, 0.005%, 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5%, and 4.5%, by the combined weight of the cellulosic derivative and any additives included therewith, encompassing any value and subset therebetween.

In yet other embodiments, the cellulosic derivative for use in forming the downhole tools or components thereof described herein may further comprise an antistatic agent additive. The antistatic agent may provide a reduction of elimination of static electricity which may be generated in some subterranean formation operations (e.g., during drilling or casing operations, and the like). Suitable antistatic agents for use in the embodiments described herein may include, but are not limited to, an anionic antistatic agent, a cationic antistatic agent, a nonionic antistatic agent, an amphoteric antistatic agent, and the like, and any combination thereof. Specific anionic antistatic agents may include, but are not be limited to, alkali sulfates, alkali phosphates, phosphate esters of alcohols, phosphate esters of ethoxylated alcohols, and the like, and any combination thereof. Suitable commercially available anionic antistatic agents may include, but are not limited to, TRYFAC® 559 and TRYFRAC® 5576, alkali neutralized phosphate ester antistatic agents available from Henkel Corporation in Mauldin, S.C. Specific cationic antistatic agents possess positive charge and may include, but are not limited to, quaternary ammonium salts, imidazolines, and the like, and any combination thereof.

Specific nonionic antistatic agents may include, but are not limited to, poly(oxyalkylene) derivatives (e.g., ethoxylated fatty acids), ethoxylated fatty alcohols, ethoxylated fatty amines, alkanolamides, and the like, and any combination thereof. Suitable commercially available antistatic agents may include, but are not limited to, EMEREST® 2650, an ethoxylated fatty acid, TRYCOL® 5964, an ethoxylated lauryl alcohol, TRYMEEN® 6606, an ethoxylated tallow amine, EMID® 6545, an oleic diethanolamine, each available from Henkel Corporation in Mauldin, S.C.

In some embodiments, the antistatic agents may be present in an amount in the range of from a lower limit of about 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5% , and 4.5%, by the combined weight of the cellulosic derivative and any additives included therewith, encompassing any value and subset therebetween.

Crosslinkers may, in some embodiments, increase the strength of the cellulosic derivatives, the water resistance of the cellulosic derivatives, and when the cellulosic derivatives are adhesive cellulosic derivatives, increase the adhesive properties thereof. Examples of crosslinkers suitable for use in conjunction with an cellulosic derivative described herein may, include, but are not limited to, Lewis-acidic salts (e.g., magnesium salts, aluminum salts, and zirconium salts, and in particular chloride and nitrate salts thereof), boric acid, borate salts, phosphate salts, ammonium zirconium carbonate, potassium zirconium carbonate, metal chelates (e.g., zirconium chelates, titanium chelates, and aluminum chelates), formaldehyde crosslinkers, polyamide epichlorohydrin resin, crosslinkers like urea glyoxal adducts and alkylates thereof (e.g., methylated glyoxal adducts and N-methylolated glyoxal adduct derivatives), crosslinkers containing N-methylol groups, crosslinkers containing etherified N-methylol groups, and the like, any derivative thereof, and any combination thereof. Additional crosslinker examples may include N-hydroxymethyl-reactive resins like 1,3-dimethylol-4,5-dihydroxyimidazolidinone (4,5-dihydroxy-N,N′-dimethylolethyleneurea) or their at least partly etherified derivatives (e.g., derivatives with hydroxymethylated cyclic ethyleneureas, hydroxymethylated cyclic propyleneureas, hydroxymethylated bicyclic glyoxal diureas, hydroxymethylated bicyclic malonaldehyde diureas), and the like, and any combination thereof.

Examples of at least partly etherified derivatives of hydroxymethylated cyclic ethyleneureas for use as the may include, but are not limited to, glyoxal, urea formaldehyde adducts, melamine formaldehyde adducts, phenol formaldehyde adducts, hydroxymethylated cyclic ethyleneureas, hydroxymethylated cyclic thioethyleneureas, hydroxymethylated cyclic propyleneureas, hydroxymethylated bicyclic glyoxal diurea, hydroxymethylated bicyclic malonaldehyde diureas, polyaldehydes (e.g., dialdehydes), protected polyaldehydes (e.g., protected dialdehydes), bisulfite protected polyaldehydes (e.g., bisulfite protected dialdehydes), isocyanates, blocked isocyanates, dimethyoxytetrahydrafuran, dicarboxylic acids, epoxides, diglycidyl ether, hydroxymethyl-substituted imidazolidinone, hydroxymethyl-substituted pyrimidinones, hydroxymethyl-substituted triazinones, oxidized starch, oxidized polysaccharides, oxidized hemicellulose, and the like, any derivative thereof, and any combination thereof. In some embodiments, hydroxymethylated compounds, at least partly etherified derivatives of hydroxymethylated compounds, dialdehyde-based compounds, and/or capped dialdehyde compounds may be useful in combination with Lewis-acidic salts. One skilled in the art with the benefit of this disclosure should understand that formaldehyde crosslinkers should be excluded from use in conjunction with formaldehyde-free adhesive cellulosic derivatives, and limited in substantially formaldehyde-free adhesive cellulosic derivatives. Suitable commercially available partially etherified derivatives of hydroxymethylated cyclic ethyleneureas may include, but are not limited to, ARKOFIX® ultra-low formaldehyde crosslinking agents, available from Clariant Muttenz, Switzerland (e.g., for example ARKOFIX® NEC plus or ARKOFIX® NES).

In some embodiments, the crosslinkers may be present in an amount in the range of from a lower limit of about 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5%, and 4.5%, by the combined weight of the cellulosic derivative and any additives included therewith, encompassing any value and subset therebetween.

Insolubilizer additives may, in some embodiments, increase the hydrophobic nature of the cellulosic derivative. Suitable examples of insolubilizer additives for use in the embodiments described herein may include, but are not limited to, copolymers of polyvinyl alcohol and polyvinyl acetate, glyoxal, glycerin, sorbitol, dextrine, alpha-methylglucoside, and the like, and any combination thereof. In some embodiments, the insolubilizer agents may be present in an amount in the range of from a lower limit of about 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5%, and 4.5%, by the combined weight of the cellulosic derivative and any additives included therewith, encompassing any value and subset therebetween.

The cellulosic derivatives may, in some embodiments, comprise a flame retardant additive. The flame retardant additive may impart flame inhibition, suppression, or delay to reduce or prevent fire spreading, and may be used as a preventative additive in some embodiments described herein. suitable for use in conjunction with cellulosic derivates described herein may include, but are not limited to, silica, organophosphates, polyhalides, and the like, and any combination thereof. In some embodiments, the flame retardant may be present in an amount in the range of from a lower limit of about 0.01%, 0.1%, 0.5%, 1%, 1.5%, 2%, 2.5%, 3%, 3.5%, 4%, and 4.5% to an upper limit of about 10%, 9.5%, 9%, 8.5%, 8%, 7.5%, 7%, 6.5%, 6%, 5.5%, 5%, and 4.5%, by the combined weight of the cellulosic derivative and any additives included therewith, encompassing any value and subset therebetween.

In some embodiments, cellulosic derivatives described herein may be characterized as having a solids content (contributed to, at least in part, by some additives) ranging from a lower limit of about 4%, 8%, 10%, 12%, or 15%, to an upper limit of about 75%, 50%, 45%, 35%, or 25%, encompassing any value and subset therebetween.

The downhole tool or component (e.g., wellbore isolation device, perforating gun, well screen tool, and the like) thereof comprising a cellulosic derivative may be formed using any processes capable of forming the downhole tool or component thereof therefrom. For example, in some embodiments, the cellulosic derivative may be used to form the downhole tool or component thereof by melt processing, including, for example, compression molding, injection molding, extrusion (e.g., film, profile, and the like), forming (e.g., vacuum forming, thermo-forming, and the like), rotomolding, coating (e.g., powder coating, curtain coating, and the like), and the like.

In some examples, a solvent may be used to form the downhole tool or component thereof, where the solvent causes the cellulosic derivative to soften such that it can be molded (e.g., solvent casting). The solvent may then be substantially removed from the cellulosic derivative to halt the softening and allow the cellulosic derivative to achieve structural integrity required for the particular downhole tool or component thereof. Suitable solvents for use in forming the downhole tool or components thereof of the present disclosure may include, but are not limited to, methanol, ethanol, methylene chloride, diacetone alcohol, lower alkanoic acids (e.g., formic acid, acetic acid, propionic acid, and the like), lower alkyl ketones (e.g., acetone, methyl ethyl ketone, methyl propyl ketone, methyl isobutyl ketone, methyl n-amyl ketone, and the like), non-cellulosic esters (e.g., methyl acetate, ethyl acetate, isopropyl acetate, n-propyl acetate, n-butyl acetate, 2-ethylhexyl acetate, isobutyl acetate, 2-butoxy-ethyl acetate, 1-methoxy-2-porpyl acetate, 2-ethoxy-ethyl acetate, ethyl-3-ethoxypropionate, isobutyl isobutyrate, 2,2,4-trimethyl-1,3-pentanediolmonoisobutyrate, and the like), non-cellulosic ethers (e.g., ethylene glycol butyl ether, propylene glycol propyl ether, 2-ethoxyethanol, 2-propoxyethanol, 2-butoxyethanol, and the like), and the like, and combinations thereof.

Where a solvent is used to form the downhole tool or component thereof using cellulosic derivatives, the type of cellulosic derivative (e.g., degree of substitution of the cellulosic derivative), type of solvent, concentration of solvent, and amount of time the cellulosic derivative is exposed to the solvent is imperative, as excessive or prolonged exposure may further soften the cellulosic derivative to cause it to “degrade,” as described herein. Other factors may also be considered including, but not limited to, the type of substituent, the degree of oxidation, the molecular weight, and the like. Indeed, exposure to a solvent is a means of degradation of the downhole tools or components thereof comprising the cellulosic alternatives, in accordance with an embodiment described herein, and described below. When the solvent is used to form the downhole tool or component thereof, it may generally be exposed to the cellulosic derivative in an amount in the range of a lower limit of about 30%, 32.5%, 35%, 37.5%, 40%, 42.5%, 45%, 47.5%, 50%, 52.5%, 55%, 57.5%, and 60% to an upper limit of about 95%, 92.5%, 90%, 87.5%, 85%, 82.5%, 80%, 77.5%, 75%, 72.5%, 70%, 67.5%, 65%, 62.5%, and 60% by the combined weight of the cellulosic derivative and any additives included therewith, encompassing any value and subset therebetween.

Combinations of melt processing and solvent forming may also be used to form the downhole tools or components thereof comprising cellulosic derivatives, without departing from the scope of the present disclosure.

The degradation of the cellulosic derivative forming a downhole tool or component thereof (including the cellulosic derivative with any one or more additives) may be achieved in a downhole environment by any mechanism. In some instances, the mechanism of degradation may include, but is not limited to, by chain scission, dissolution, chemical decomposition, oxidation, reduction, debonding, embrittlement, corrosion, softening, swelling, dissolving, hydrolytic decomposition, undergoing a chemical change, catalyzed degradation, acid catalysis degradation, enzymatic degradation, photocatalytic degradation, and any combination thereof.

Degradation by debonding includes a loss of adhesion characteristics of the cellulosic materials, as described above, such that the mechanical integrity of the downhole tool or component thereof is broken into smaller products that fall to the bottom of the wellbore. Degradation by softening may result in exposure of the cellulosic derivative to the downhole environment, resulting in a weakening of the mechanical integrity of the downhole tool or component thereof formed from the cellulosic derivative. For example, the downhole tool or component thereof may be a wellbore isolation devices and contact with the downhole environment may cause a softening of the cellulosic material such that the wellbore isolation device is no longer able to maintain such isolation and detaches from the face of the wellbore. Degradation by swelling involves the absorption by the cellulosic derivative of the fluids in the wellbore environment (e.g., aqueous fluids, hydrocarbon fluids, brine fluids, and the like, and combinations thereof) such that the mechanical properties of the cellulosic derivative degrade. That is, the cellulosic derivative continues to absorb the fluid until its mechanical properties are no longer capable of maintaining the integrity of the downhole tool or component thereof and it at least partially falls apart. The fluid may be either naturally occurring in the wellbore environment or placed therein, without departing from the scope of the present disclosure.

Degradation by dissolving involves use of a cellulosic derivative that is soluble or otherwise susceptible to wellbore fluids, such that the fluid is not necessarily incorporated into the cellulosic derivative (as is the case with degradation by swelling), but becomes soluble upon contact with the fluid. Degradation by undergoing a chemical change may involve breaking the bonds of the backbone of the cellulosic derivative or causing the bonds of the cellulosic derivative to crosslink, such that the cellulosic derivative becomes brittle and breaks into small pieces upon contact with even small forces expected in the wellbore environment. The chemical change may be the result of any condition in the wellbore environment such as, but not limited to, temperature, pressure, wellbore fluids, gasses (e.g., dissolved gasses), introduction or release of a chemical (i.e., acid, based, solvent), introduction of an energetic source (i.e., electromagnetic radiation, radioactive source), and the like. Catalyzed degradation involves degradation of the cellulosic derivative by contact with a catalytic agent, which may be introduced into the wellbore environment specifically for contact with the cellulosic derivative to initiate or accelerate degradation thereof. In some instances, the exposure of the cellulosic derivative may be controlled by certain methods, such as those described below.

Referring now to catalytic degradation, such catalytic degradation may be accomplished by any means suitable in a wellbore environment for degrading a cellulosic derivative as described herein, without departing from the scope of the present disclosure. In some embodiments, the catalytic degradation may be achieved by controlled release of a catalytic agent from a polymer capsule, for example. The polymer capsule may be designed to undergo degradation, such as by swelling, that releases a catalytic agent for at least partially degrading the cellulosic derivative forming the downhole tool or component thereof. In some embodiments, the polymer capsule may be comingled or otherwise within the structure, or surrounding or surrounded by the structure, of the cellulosic derivative forming the downhole tool or component thereof, comingled or otherwise within the structure of another material forming the downhole tool or component thereof, or wholly separate to the downhole tool or component thereof (e.g., introduced after the downhole tool has performed a desired operation), without departing from the scope of the present disclosure.

The polymer capsule may itself be of a degradable material. In some instances, the polymer capsule may be degradable such that it is broken down at least into smaller products that may be environmentally innocuous products. Such degradation may be the result of action of one or more microbial organisms, or non-microbial action. For example, in some embodiments, exposure to natural metal salts and water in a wellbore environment, or other possible catalytic agents, may assist in effecting degradation. Other wellbore environmental conditions that may assist in degradation, as previously discussed, may include, but are not limited to, temperature, pressure, exposure to light (e.g., artificial light introduced into the wellbore), wellbore fluids (e.g., aqueous, brine, hydrocarbon, and the like), without departing from the scope of the present disclosure.

The polymer capsule may be composed of a flexible polymer comprising a material including, but not limited to, gelatin, chitosan, locust bean gum, starch, pectin, agar, alginic acid, salts of alginic acid, carrageenans, sorghum, thermal polyaspartate (TPA), polyvinyl alcohol, polyvinyl acetate (PVAc), polylactic acid (PLA), polyglycolic acid (PGA), polybutylene succinate (PBS), polyhydroxy-alkanoate (PHA) (e.g., poly-3-hydroxypropionate (p(3-HP)), polycaprolactone (PCL), and the like, any copolymer thereof, and derivative thereof, and any combination thereof. The flexible polymer may be a gel, without departing from the scope of the present disclosure.

The flexible polymers may be present in the range of a lower limit of about 10%, 15%, 20%, 25%, 30%, 35%, 40%, 45% to an upper limit of about 75%, 70%, 65%, 60%, 55%, 50%, and 45% by weight of the polymer capsule, encompassing any value and subset therebetween.

The flexible polymer may be designed to swell upon exposure to large quantities of fluid, such as aqueous fluids (e.g., water), such that the swelling of the flexible polymer aids in the release of a cellulosic derivative catalytic agent (e.g., a cellulose ester hydrolysis catalytic agent). The term “flexible polymer” means any polymer having at least some elastic behavior. In some embodiments, the flexible polymer comprising the polymer capsule may further comprise a foam, a gelling agent, a plasticizer, and any combination thereof.

The foams included in the flexible polymer may be used to impart increased compliance and/or increased elasticity to the flexible polymer. Such foams may include, but are not limited to, grain sorghum foams, corn starch foams (e.g., such as packing material foams). In some embodiments, the foam may be present in an amount in the range of a lower limit of about 1%, 2.5%, 5%, 7.5%, 10%, 12.5%, 15%, 17.5%, 20%, 22.5%, and 25% to an upper limit of about 50%, 47.5%, 45%, 42.5%, 40%, 37.5%, 35%, 32.5%, 30%, 27.5%, and 25% by weight of the flexible polymer, encompassing any value and subset therebetween.

A gelling agent may be used to impart increased viscosity to the flexible polymer. Suitable gelling agents may include, but are not limited to, hydroxyaIkylguar, carboxyaIkylhydroxyguar, carboxyaIkylhydroxyaIkylguar, poly(ethylene imine), guar, xanthan, a polysaccharide, a synthetic polymer, and the like, and any combination thereof. In some embodiments, the foam may be present in an amount in the range of a lower limit of about 1%, 2.5%, 5%, 7.5%, 10%, 12.5%, 15%, 17.5%, 20%, 22.5%, and 25% to an upper limit of about 50%, 47.5%, 45%, 42.5%, 40%, 37.5%, 35%, 32.5%, 30%, 27.5%, and 25% by weight of the flexible polymer, encompassing any value and subset therebetween.

In some embodiments, the flexible polymer may further comprise a plasticizer to impart malleability to the polymer capsule. The plasticizer may be any substance capable of imparting malleability to the polymer capsule and may, in some instances, itself be degradable (or biodegradable). Suitable plasticizers for use in the embodiments described herein may include, but are not limited to, sorbitol, glycerin, acetylated monoglycerides, alkyl citrates (e.g., triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC, trihexyl o-butyryl citrate), trimethyl citrate (TMC), and the like), alkyl sulphonic acid phenyl esters (ASEs), 1,2-cyclohexane dicarboxylic acid diisononyl ester, and the like, and any combination thereof. Any of the aforementioned plasticizers may be used alone or in combination.

In some embodiments, the plasticizer may be present in the range of an amount from a lower limit of about 5%, 10%, 20%, 25%, and 30% to an upper limit of about 50%, 45%, 40%, 35%, and 30% by weight of the polymer capsule, encompassing any value and subset therebetween. It will be recognized that the amount of plasticizer may depend on the type of flexible polymer and plasticizer selected, and in some instances the flexible polymer itself may exhibit the requisite flexibility and a plasticizer may not be needed. In some instances, the ratio of the flexible polymer to plasticizer may be in a range from about 50:50 to about 95:5, including about 50:50, about 60:40, about 70:30, about 85:15, and about 95:5, encompassing any value and subset therebetween.

In some embodiments, the polymer capsules may comprise a catalytic agent that may be released upon swelling of the flexible polymer. The catalytic agent may be contained within the structure of the flexible polymer or may be comingled therewith and a degradable coating surrounding the flexible polymer. The catalytic agents may initiate or accelerate degradation of the cellulosic derivatives described herein by catalytic hydrolysis thereof. As used herein, “catalyze hydrolysis” refers to the hydrolytic cleavage of a moiety on the cellulose backbone, such as an ester moiety. As an example, in some embodiments, all ester moieties are cleavable by action of the catalytic agent, although such a condition is not necessary for degradation or partial degradation of the cellulosic derivative. As further example, with respect to cellulose acetate, a DS of about 0.1 to about 1.0 is sufficient for degradation, for example, by naturally occurring enzymes and bacteria. In this context, the DS refers to the average number of acetate groups per monomeric unit, glucose, or cellulose. For example, cellulose acetate with a DS of 1 has on average one acetate group per glucose monomer. For hydrolysis of the cellulose acetate to occur, only the substrate cellulose acetate, the catalytic agent, and water may be needed.

The catalytic agents of the present disclosure may include, but are not limited to, acids, acid salts (e.g., salts of polyprotic acids), bases, bacteria, and the like, and any combination thereof. The amount of catalytic agents present in the polymer capsules of the present disclosure should be sufficient to cause degradation or partial degradation of the cellulosic derivative forming the downhole tool or component thereof at a desired rate. For example, in some embodiments, the time for degradation may be in a range of from about 2 months to about 6 months. The amount of the catalytic agent may depend upon, for example, the % weight of the cellulosic derivative in the downhole tool or component thereof, the desired time for degradation of the downhole tool or component thereof, the type of cellulosic derivative(s) selected, any additives included in the cellulosic derivative, the type of catalytic agent(s) selected, and the like.

In some embodiments, suitable acids or salts thereof may include, but are not limited to, acetic acid, ascorbic acid, ascorbyl-2-phosphate, ascorbyl-2-sulfate, aspartic(aminosuccinic), cinnamic acid, citric acid, folic acid, glutaric acid, inositol phosphate(phytic acid), lactic, malic(1-hydroxysuccinic), nicotinic(nician), oxalic acid, succinic acid, tartaric acid, boric acid, hydrochloric acid, nitric acid, phosphoric acid, sulfuric acid, and the like, and any combination thereof. In some embodiments, the catalytic agents described herein may include acids, acid salts, bases, and bacterium adapted to generate an acid. In some embodiments, acids may have a pKₐ of less than about 6 may be preferred. In some embodiments, bases may have a pK_{b} of less than about 6 may be preferred.

In some embodiments, the acid catalytic agents may include a combination of a weak organic acid and a compound that may be hydrolyzed to a strong acid. In such a combination, the weak organic acid may hydrolyze the compound, liberating the stronger acid, and the strong acid may hydrolyze the cellulosic derivative for degradation. Suitable weak organic acids may include, but are not limited to, ascorbic acid, citric acid, lactic acid, nicotinic acid, hydroxysuccinic acid, and the like, and any combination thereof. Suitable compounds that may be hydrolyzed to provide a strong acid may include, but are not limited to, cellulose sulfate, dodecyl sulfate, ascorbyl-2-sulfate, ascorbyl-2-phosphate, phosphorus pentoxide, phosphorus pentoxide based esters, cellulose nitrate, 2-ethyl hexyl phosphate, and the like, any derivatives thereof, and any combination thereof.

Suitable acid salts for use as the catalytic agents described herein may include, but are not limited to, an alum (e.g., aluminum potassium sulfate, aluminum ammonium sulfate, and the like, sodium hydrogen sulfate, sodium dihydrogen phosphate, metal salts, and the like, and any combination thereof. When the acid salt selected is a metal salt, the metal thereof may include, but is not limited to, aluminum, potassium, sodium, zinc, and the like, and any combination thereof; corresponding counterions may also be used including, but not limited to, nitrates, dihydrogen phosphates, hydrogen phosphates, phosphates hydrogen sulfates, sulfates, and combinations thereof.

In some embodiments, where the selected catalytic agent is an acid or an acid salt and the target time for degradation is in a range from about 2 months to about 6 months, the amount of acid or an acid salt may be in a range in an amount of from a lower limit of about 2%, 10%, 20%, 30%, 40%, 50%, 60%, 70%, 80%, 90%, and 100% to an upper limit of about 200%, 190%, 180%, 170%, 160%, 150%, 140%, 130%, 120%, 110%, and 100% by weight of the cellulosic derivative comprising the downhole tool or component thereof, encompassing any value and subset therebetween, such as between about 5% and about 100%, or about 10% and about 50%, and the like.

Suitable bases for use as the catalytic agent may include, but are not limited to, metal hydroxides, calcium oxide (lime), urea, borax, sodium metasilicate, ammonium hydroxide, sodium carbonate, sodium phosphate tribasic, sodium hypochlorite, sodium hydrogen carbonate (sodium bicarbonate), and the like, and any combination thereof.

In some embodiments, where the selected catalytic agent is a base and the target time for degradation is in a range from about 2 months to about 6 months, the amount of base may be in a range in an amount of from a lower limit of about 50%, 75%, 100%, 125%, 150%, 175%, 200%, 225%, and 250% to an upper limit of about 500%, 475%, 450%, 425%, 400%, 375%, 350%, 325%, 300%, 275%, and 250% by weight of the cellulosic derivative comprising the downhole tool or component thereof, encompassing any value and subset therebetween, such as between about 80% and about 300%, or about 100% and about 200%, and the like.

Bacteria that may be used as the catalytic agents described herein may include bacteria capable of producing an acid, bacteria that attack and degrade cellulosic derivatives (or their substituents) directly, and any combination thereof. Bacteria that produce acid are typically provided with a food source. Thus, when the bacterium is released from the polymer capsule, such as by swelling action of water, the bacterium will digest the food source, produce a weak acid, and the weak acid may catalyze the hydrolysis of the cellulosic derivative. In some embodiments, suitable bacterium for use in the embodiments described herein may include, but is not limited to, lactobacillus acidophilus, bifidobacterium longum, acetobacterium woodii, acetobacter aceti (vinegar bacteria), and the like, and any combination thereof. The food source for the bacteria may be any conventional bacterium food source including, but not limited to, lactose, glucose, triactin-based substances, and the like, and any combination thereof. Bacteria that attacks and degrades cellulosic derivatives directly do not require the food source. Suitable examples of such bacteria may include, but are not limited to, rhizobium meliloti, alcaligenes xylosoxidans, and the like, and combinations thereof.

In some embodiments, where the selected catalytic agent is a bacteria and the target time for degradation is in a range from about 2 months to about 6 months, the amount of bacteria may be in a range in an amount of from a lower limit of about 1 colony forming unit (cfu); 100 cfu; 1,000 cfu; and 10,000 cfu to an upper limit of about 1,000,000,000 cfu; 100,000,000 cfu; 10,000,000 cfu; 1,000,000 cfu; 100,000 cfu; and 10,000 cfu, encompassing any value and subset therebetween, such as from about 100 cfu to about 100,000,000 cfu, or from about 1,000 cfu to about 10,000,000 cfu, or from about 10,000 cfu to about 1,000,00 cfu, and the like. The bacteria may further be included as the catalytic agent in combination with required nutrients therewith.

In forming the polymeric capsule, at least one permeable coating may be disposed substantially about the flexible polymer and the catalytic agent. The permeable coating may be wholly coated about the flexible polymer and the catalytic agent, or only partially coated thereabout (e.g., in a porous structure). The coating may be of any type that modulates the release of the catalytic agent(s) or the swelling of the flexible polymer(s) encased therein. In some embodiments, the polymer capsules may be completely coated with one or more layers of the permeable coating and holes may be introduced in one or more of the layers to modulate release. For example, modulated release holes may be formed by use of a pin drill or the like to introduce holes in any pattern through one or more permeable coating layers. In some embodiments, the permeable coating may be water permeable.

In some embodiments, permeable coating may itself comprise cellulosic ethers, such as methyl cellulose, ethyl cellulose, carboxy methyl cellulose, hydroxypropyl cellulose, hydroxyethyl cellulose, and hydroxy propylmethyl cellulose, and the like, any derivatives thereof, and any combination thereof. In some embodiments, the permeable coating may have modified release characteristics made of materials including, but not limited to, polysaccharide based polymers, cellulose acetate, cellulose triacetate, cellulose nitrate, cellulose sulfate, sodium salt, cellulose phosphate, cellulose acetate phthalate, polyvinylacetate phthalate, methylcellulose phthalate, ethylhydroxycellulose phthalate, hydroxypropylmethyl cellulose phthalate, cellulose acetate succinate, acetate trimellitate, polyvinyl butyrate acetate, vinyl acetate-maleic anhydride copolymer, styrene-maleic mono-ester copolymer, ethylcellulose, a cellulose ester, shellac, polyvinyl alcohol, sodium alginate, methyl acrylate-methacrylic acid copolymer, methacrylate-methacrylic acid-octyl acrylate copolymer, and the like, any derivatives thereof, and any combination thereof. In some embodiments, the selection of permeable coating may also be selected to be degradable as described herein.

In some embodiments, the polymer capsules of the present disclosure may have permeable coatings that are multilayered, where such multilayered permeable coatings substantially coat the entirety of the polymer capsules or partially coating the capsule, as described above. The number of permeable coating layers is not limited in accordance with the present disclosure. In some embodiments, the permeable coating may have 1 layer, or may employ 2, 3, 4, 5, 6 layers, or even more, without departing from the scope of the present disclosure. Processing complexity, processing time, and/or cost may increase with increasing permeable coating layers.

Other coatings that may be used to form the polymer capsules include any known coatings having a porous structure. The porous structure may be the natural structure of the material, or alternatively pores of controlled dimensions may be introduced into the coating, for example by drilling or other means.

In some embodiments, an inner permeable coating layer may comprise ethylcellulose or hydroxypropylmethyl cellulose, or any of the permeable coating materials listed above. As used herein, the term “inner layer” refers to any intermediate layer disposed beneath an outer layer, where more than a two-layered coating is present. In some embodiments, the polymer capsules of the present disclosure may have an outer layer comprising cellulose acetate, or any of the permeable coating materials listed above.

Embodiments disclosed herein:

Embodiment A: A downhole tool or component thereof comprising a cellulosic derivative, wherein the cellulosic derivative is capable of at least partially degrading in a wellbore environment, thereby at least partially degrading the downhole tool or component thereof.

Embodiment A may have one or more of the following additional elements in any combination:

Element A1: Wherein the cellulosic derivative is derived from a cellulosic source having the general structure of:

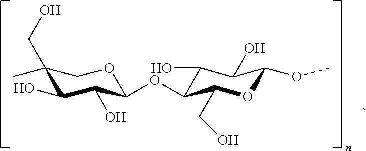

wherein at least one —OH group is substituted with a reagent selected from the group consisting of acetic acid, acetic anhydride, propanoic acid, butyric acid, nitric acid, a nitrating agent, sulfuric acid, a sulfuring agent, a halogenoalkane, an epoxide, a halogenated carboxylic acid, and any combination thereof, and wherein n is in the range of from about 10 to about 100000.

Element A2: Wherein the cellulosic derivative has the general structure:

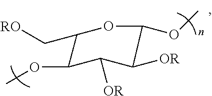

wherein R is selected from the group consisting of —(C═O)CH3, —(C═O)CH2CH3, —(C═O)CH₂CH₂CH₃, —NO₂, —SO₃H, —CH₃, —CH₂CH₃, —CH₂CH₂OH, —CH₂CH(OH)CH₃, —CH₂COOH, —H, and any combination thereof.

Element A3: Wherein the cellulosic derivative has an average molecular weight in the range of from about 5000 g/mol to about 400000 g/mol.

Element A4: Wherein the cellulosic derivative is selected from the group consisting of a cellulose ester, a cellulose ether, and any combination thereof.

Element A5: Wherein the cellulosic derivative is a cellulose ester that comprises a cellulose polymer backbone having an organic ester substituent and an inorganic ester substituent, wherein the inorganic ester substituent comprises an inorganic, nonmetal atom selected from the group consisting of sulfur, phosphorus, boron, and chlorine.

Element A6: Wherein the cellulosic derivative further comprises an additive selected from the group consisting of a plasticizer, a pigment, a modifier, a tackifier, a lubricating agent, an emulsifier, an antimicrobial agent, an antistatic agent, a crosslinker, an indicator, a stabilizer, an antioxidant, a wax, an insolubilizer, a water-resistant additive, a flame retardant, a softening agent, an antifungal agent, and any combination thereof.

Element A7: Wherein the downhole tool is selected from the group consisting of a wellbore isolation device, a perforating gun, or a well screen tool.

Element A8: Wherein the component thereof is selected from the group consisting of a mandrel, a sealing element, a spacer ring, a slip, a wedge, a retainer ring, an extrusion limiter, a backup shoe, a mule shoe, a tapered shoe, a flapper, a ball, a ball seat, an o-ring, a sleeve, an enclosure, a fluid enclosure, a dart, a valve, a connection, a latch, an actuator, an actuation control device, an outer body, a charge carrier, a cover, a well screen, and any combination thereof.

By way of non-limiting example, exemplary combinations applicable to Embodiment A include: A with A1, A5, and A8; A with A1, A2, A3, A4, A5, A6, A7, and A8; A with A3, A6, A7, and A8; A with A1, A2, and A4; A with A5 and A7; and the like.

Embodiment B: A method comprising: providing a downhole tool, wherein the downhole tool or a component thereof comprises a cellulosic derivative, and wherein the cellulosic derivative is capable of at least partially degrading in a wellbore environment, thereby at least partially degrading the downhole tool or component thereof; introducing the downhole tool into the wellbore; performing a downhole operation; and at least partially degrading the downhole tool or component thereof in the wellbore.

Embodiment B may have one or more of the following additional elements in any combination:

Element B1: Wherein the cellulosic derivative is derived from a cellulosic source having the general structure of:

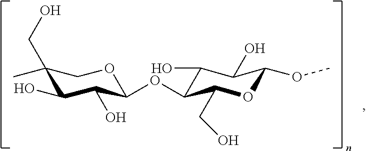

wherein at least one —OH group is substituted with a reagent selected from the group consisting of acetic acid, acetic anhydride, propanoic acid, butyric acid, nitric acid, a nitrating agent, sulfuric acid, a sulfuring agent, a halogenoalkane, an epoxide, a halogenated carboxylic acid, and any combination thereof, and wherein n is in the range of from about 10 to about 100000.

Element B2: Wherein the cellulosic derivative has the general structure:

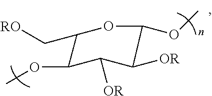

wherein R is selected from the group consisting of —(C═O)CH3, —(C═O)CH2CH3, —(C═O)CH₂CH₂CH₃, —NO₂, —SO₃H, —CH₃, —CH₂CH₃, —CH₂CH₂OH, —CH₂CH(OH)CH₃, —CH₂COOH, —H, and any combination thereof.

Element B3: Wherein the cellulosic derivative has an average molecular weight in the range of from about 5000 g/mol to about 400000 g/mol.

Element B4: Wherein the cellulosic derivative is selected from the group consisting of a cellulose ester, a cellulose ether, and any combination thereof.

Element B5: Wherein the cellulosic derivative is a cellulose ester that comprises a cellulose polymer backbone having an organic ester substituent and an inorganic ester substituent, wherein the inorganic ester substituent comprises an inorganic, nonmetal atom selected from the group consisting of sulfur, phosphorus, boron, and chlorine.

Element B6: Wherein the cellulosic derivative further comprises an additive selected from the group consisting of a plasticizer, a pigment, a modifier, a tackifier, a lubricating agent, an emulsifier, an antimicrobial agent, an antistatic agent, a crosslinker, an indicator, a stabilizer, an antioxidant, a wax, an insolubilizer, a water-resistant additive, a flame retardant, a softening agent, an antifungal agent, and any combination thereof.

Element B7: Wherein the downhole tool is selected from the group consisting of a wellbore isolation device, a perforating gun, or a well screen tool.

Element B8: Wherein the component thereof is selected from the group consisting of a mandrel, a sealing element, a spacer ring, a slip, a wedge, a retainer ring, an extrusion limiter, a backup shoe, a mule shoe, a tapered shoe, a flapper, a ball, a ball seat, an o-ring, a sleeve, an enclosure, a fluid enclosure, a dart, a valve, a connection, a latch, an actuator, an actuation control device, an outer body, a charge carrier, a cover, a well screen, and any combination thereof.

Element B9: Further comprising removing the degraded downhole tool or component thereof from the wellbore.

By way of non-limiting example, exemplary combinations applicable to Embodiment B include: B with B5, B6, and B9; B with B1, B2, B8, and B9; B with B1, B2, B3, B4, B5, B6, B7, B8, and B9; B with B3, B5, and B7; B with B3, B5, B7, and B9; and the like.

Embodiment C: A system comprising: a wellbore; and a downhole tool capable of being disposed in the wellbore to perform a downhole operation, the downhole tool or a component thereof comprising a cellulosic derivative, and wherein the cellulosic derivative is capable of at least partially degrading in the wellbore environment, thereby at least partially degrading the downhole tool or component thereof.

Embodiment C may have one or more of the following additional elements in any combination:

Element C1: Wherein the cellulosic derivative is derived from a cellulosic source having the general structure of:

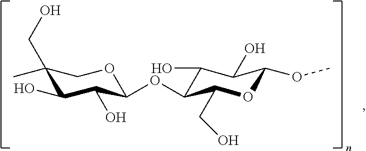

wherein at least one —OH group is substituted with a reagent selected from the group consisting of acetic acid, acetic anhydride, propanoic acid, butyric acid, nitric acid, a nitrating agent, sulfuric acid, a sulfuring agent, a halogenoalkane, an epoxide, a halogenated carboxylic acid, and any combination thereof, and wherein n is in the range of from about 10 to about 100000.

Element C2: Wherein the cellulosic derivative has the general structure:

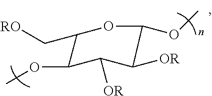

wherein R is selected from the group consisting of —(C═O)CH3, —(C═O)CH2CH3, —(C═O)CH₂CH₂CH₃, —NO₂, —SO₃H, —CH₃, —CH₂CH₃, —CH₂CH₂OH, —CH₂CH(OH)CH₃, —CH₂COOH, —H, and any combination thereof.

Element C3: Wherein the cellulosic derivative has an average molecular weight in the range of from about 5000 g/mol to about 400000 g/mol.

Element C4: Wherein the cellulosic derivative is selected from the group consisting of a cellulose ester, a cellulose ether, and any combination thereof.

Element B5: Wherein the cellulosic derivative is a cellulose ester that comprises a cellulose polymer backbone having an organic ester substituent and an inorganic ester substituent, wherein the inorganic ester substituent comprises an inorganic, nonmetal atom selected from the group consisting of sulfur, phosphorus, boron, and chlorine.

Element C6: Wherein the cellulosic derivative further comprises an additive selected from the group consisting of a plasticizer, a pigment, a modifier, a tackifier, a lubricating agent, an emulsifier, an antimicrobial agent, an antistatic agent, a crosslinker, an indicator, a stabilizer, an antioxidant, a wax, an insolubilizer, a water-resistant additive, a flame retardant, a softening agent, an antifungal agent, and any combination thereof.

Element C7: Wherein the downhole tool is selected from the group consisting of a wellbore isolation device, a perforating gun, or a well screen tool.

Element C8: Wherein the component thereof is selected from the group consisting of a mandrel, a sealing element, a spacer ring, a slip, a wedge, a retainer ring, an extrusion limiter, a backup shoe, a mule shoe, a tapered shoe, a flapper, a ball, a ball seat, an o-ring, a sleeve, an enclosure, a fluid enclosure, a dart, a valve, a connection, a latch, an actuator, an actuation control device, an outer body, a charge carrier, a cover, a well screen, and any combination thereof.

By way of non-limiting example, exemplary combinations applicable to Embodiment C include: C with C1, C5, and C8; C with C2, C4, C6, and C7; C with C1, C2, C3, C4, C5, C6, C7, and C8; C with C3, C4, C7, and C8; C with C5 and C6; and the like.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A downhole tool or component thereof comprising a cellulosic derivative,
wherein the cellulosic derivative is capable of at least partially degrading in a wellbore environment, thereby at least partially degrading the downhole tool or component thereof.

2. The downhole tool or component thereof of claim 1, wherein the cellulosic derivative is derived from a cellulosic source having the general structure of: 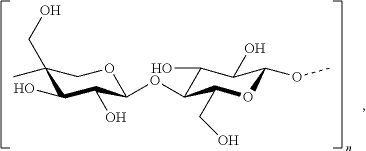
wherein at least one —OH group is substituted with a reagent selected from the group consisting of acetic acid, acetic anhydride, propanoic acid, butyric acid, nitric acid, a nitrating agent, sulfuric acid, a sulfuring agent, a halogenoalkane, an epoxide, a halogenated carboxylic acid, and any combination thereof, and wherein n is in the range of from about 10 to about 100000.

3. The downhole tool or component thereof of claim 1, wherein the cellulosic derivative has the general structure: 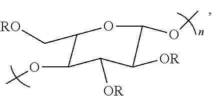
wherein R is selected from the group consisting of —(C═O)CH3, —(C═O)CH2CH3, —(C═O)CH₂CH₂CH₃, —NO₂, —SO₃H, —CH₃, —CH₂CH₃, —CH₂CH₂OH, —CH₂CH(OH)CH₃, —CH₂COOH, —H, and any combination thereof.

4. The downhole tool or component thereof of claim 1, wherein the cellulosic derivative has an average molecular weight in the range of from about 5000 g/mol to about 400000 g/mol.

5. The downhole tool or component thereof of claim 1, wherein the cellulosic derivative is selected from the group consisting of a cellulose ester, a cellulose ether, and any combination thereof.

6. The downhole tool or component thereof of claim 1, wherein the cellulosic derivative is a cellulose ester that comprises a cellulose polymer backbone having an organic ester substituent and an inorganic ester substituent, wherein the inorganic ester substituent comprises an inorganic, nonmetal atom selected from the group consisting of sulfur, phosphorus, boron, and chlorine.

7. The downhole tool or component thereof of claim 1, wherein the cellulosic derivative further comprises an additive selected from the group consisting of a plasticizer, a pigment, a modifier, a tackifier, a lubricating agent, an emulsifier, an antimicrobial agent, an antistatic agent, a crosslinker, an indicator, a stabilizer, an antioxidant, a wax, an insolubilizer, a water-resistant additive, a flame retardant, a softening agent, an antifungal agent, and any combination thereof.

8. The downhole tool or component thereof of claim 1, wherein the downhole tool is selected from the group consisting of a wellbore isolation device, a perforating gun, or a well screen tool.

9. The downhole tool of component thereof of claim 1, wherein the component thereof is selected from the group consisting of a mandrel, a sealing element, a spacer ring, a slip, a wedge, a retainer ring, an extrusion limiter, a backup shoe, a mule shoe, a tapered shoe, a flapper, a ball, a ball seat, an o-ring, a sleeve, an enclosure, a fluid enclosure, a dart, a valve, a connection, a latch, an actuator, an actuation control device, an outer body, a charge carrier, a cover, a well screen, and any combination thereof.

10. A method comprising:
providing a downhole tool, wherein the downhole tool or a component thereof comprises a cellulosic derivative, and
wherein the cellulosic derivative is capable of at least partially degrading in a wellbore environment, thereby at least partially degrading the downhole tool or component thereof;
introducing the downhole tool into the wellbore;
performing a downhole operation; and
at least partially degrading the downhole tool or component thereof in the wellbore.

11. A method of claim 10, further comprising removing the degraded downhole tool or component thereof from the wellbore.

12. The method of claim 10, wherein the cellulosic derivative is derived from a cellulosic source having the general structure of: 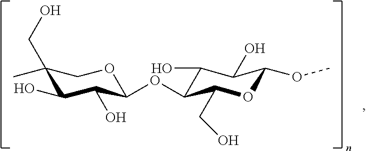
wherein at least one —OH group is substituted with a reagent selected from the group consisting of acetic acid, acetic anhydride, propanoic acid, butyric acid, nitric acid, a nitrating agent, sulfuric acid, a sulfuring agent, a halogenoalkane, an epoxide, a halogenated carboxylic acid, and any combination thereof, and wherein n is in the range of about 10 to about 100000.

13. The method of claim 10, wherein the cellulosic derivative has the general structure: 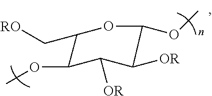
wherein R is selected from the group consisting of —(C═O)CH3, —(C═O)CH2CH3, —(C═O)CH₂CH₂CH₃, —NO₂, —SO₃H, —CH₃, —CH₂CH₃, —CH₂CH₂OH, —CH₂CH(OH)CH₃, —CH₂COOH, —H, and any combination thereof.

14. The method of claim 10, wherein the cellulosic derivative has an average molecular weight in the range of from about 5000 g/mol to about 400000 g/mol.

15. The method of claim 10, wherein the cellulosic derivative is selected from the group consisting of a cellulose ester, a cellulose ether, and any combination thereof.

16. The method of claim 10, wherein the cellulosic derivative is a cellulose ester that comprises a cellulose polymer backbone having an organic ester substituent and an inorganic ester substituent, wherein the inorganic ester substituent comprises an inorganic, nonmetal atom selected from the group consisting of sulfur, phosphorus, boron, and chlorine.

17. The method of claim 10, wherein the downhole tool is selected from the group consisting of a wellbore isolation device, a perforating gun, or a well screen tool.

18. The method of claim 10, wherein the component thereof is selected from the group consisting of a mandrel, a sealing element, a spacer ring, a slip, a wedge, a retainer ring, an extrusion limiter, a backup shoe, a mule shoe, a tapered shoe, a flapper, a ball, a ball seat, an o-ring, a sleeve, an enclosure, a fluid enclosure, a dart, a valve, a connection, a latch, an actuator, an actuation control device, an outer body, a charge carrier, a cover, a well screen, and any combination thereof.

19. A system comprising:
a wellbore; and
a downhole tool capable of being disposed in the wellbore to perform a downhole operation, the downhole tool or a component thereof comprising a cellulosic derivative, and
wherein the cellulosic derivative is capable of at least partially degrading in the wellbore environment, thereby at least partially degrading the downhole tool or component thereof.

20. The system of claim 19, wherein the cellulosic derivative is derived from a cellulosic source having the general structure of: 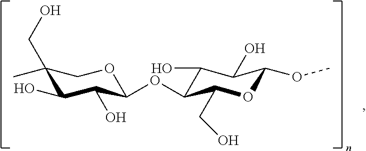
wherein at least one —OH group is substituted with a reagent selected from the group consisting of acetic acid, acetic anhydride, propanoic acid, butyric acid, nitric acid, a nitrating agent, sulfuric acid, a sulfuring agent, a halogenoalkane, an epoxide, a halogenated carboxylic acid, and any combination thereof, and wherein n is in the range of from about 10 to about 100000.

21-26. (canceled)
